(19) United States
(12) Patent Application Publication
(10) Pub. No.: US 2018/0089628 A1
(43) Pub. Date: Mar. 29, 2018

(54) Computer Mediated Authoring Tool for Performance Reviews

(71) Applicant: Unitive, Inc., Woodside, CA (US)

(72) Inventors: Laura Anne Mather, Woodside, CA (US); Catherine Paige Panter, San Francisco, CA (US); Samuel Davis Panter, San Francisco, CA (US); James Schumacher, Oakland, CA (US); Daniel Joong-Hee Kim, South San Francisco, CA (US)

(73) Assignee: Unitive, Inc., Woodside, CA (US)

(21) Appl. No.: 15/809,933

(22) Filed: Nov. 10, 2017

Related U.S. Application Data
(63) Continuation of application No. 14/835,464, filed on Aug. 25, 2015.
(60) Provisional application No. 62/195,686, filed on Jul. 22, 2015.
(60) Provisional application No. 62/159,208, filed on May 8, 2015.
(60) Provisional application No. 62/130,429, filed on Mar. 9, 2015.
(60) Provisional application No. 62/085,822, filed on Dec. 1, 2014.
(60) Provisional application No. 62/058,463, filed on Oct. 1, 2014.
(60) Provisional application No. 62/041,515, filed on Aug. 25, 2014.

(51) Int. Cl. G06Q 10/10

(52) U.S. Cl. CPC G06Q 10/1053

(57) ABSTRACT

The inherent human biases related to hiring processes are mediated using automated computer based systems. Computer executed logic is configured to detect and compensate for, for example, cultural, gender, and/or racial biases. Specific applications include, but are not limited to, job descriptions, review of resumes and interviews.

### CROSS-REFERENCE TO RELATED APPLICATIONS

This application is a continuation of U.S. patent application Ser. No. 14/835,464 filed Aug. 25, 2015 which claims the benefit of and priority to U.S. Provisional Patent Application No. 62/041,515 filed Aug. 25, 2014; U.S. Provisional Patent Application No. 62/058,463 filed Oct. 1, 2014; U.S. Provisional Patent Application No. 62/085,822 filed Dec. 1, 2014; U.S. Provisional Patent Application No. 62/130,429 filed Mar. 9, 2015; U.S. Provisional Patent Application No. 62/159,208 filed May 8, 2015; and U.S. Provisional Patent Application No. 62/195,686 filed Jul. 22, 2015. The disclosures of the above provisional patent applications are hereby incorporated herein by reference.

### BACKGROUND

### Field of the Invention

The invention is in the field of computer mediated human resource management, and specifically in the field of computer mediated hiring processes.

### Related Art

Hiring processes inherently include human biases. Such biases can be cultural, gender based, racial and/or based on some other category. Even the best intentioned people are likely to introduce subconscious bias into their work. Such bias has negative consequences. For example, it may result in selecting a sub-optimal candidate for a job opening. Bias may be found in the preparation of job descriptions, review of resumes and interviews.

### SUMMARY

Various embodiments of the invention include a computing system configured to facilitate the preparation of job descriptions, the review of resumes and/or the conducting and analysis of interviews. For example, various embodiments of the invention provide a computer based job description authoring tool configured to reduce the inherent bias that is often found in job descriptions prepared by human authors. The authoring tool is configured to guide a human author in the preparation of job descriptions. This guidance includes, for example, crafting of language having reduced bias, scoring language for bias content, and providing suggestions for language including less bias. A purpose, of some embodiments, is to generate job descriptions that include less bias than job descriptions that would typically be generated by a human author alone.

Various embodiments of the invention include a computing system configured to reduce bias in the authoring of job descriptions, the computing system comprising a user interface configured for a human user to enter words of a job description; a rule base comprising a plurality of rules for the content of a job description, the plurality of rules including 1) a rule limiting a number of requirements listed in the job description, 2) a rule to avoid specific terms in the job description, and/or 3) a rule to avoid specific limits in the job description; analysis logic configured to generate a score for the job description, the score being based on compliance of the job description to the plurality of rules; storage configured to store the job description and the plurality of rules; and a microprocessor configured to execute at least the analysis logic.

Various embodiments of the invention include a computer-based tool for reviewing resumes and configured to reduce the inherent bias that occurs when humans review resumes to determine applicable candidates for a job. The review tool is configured to allow the human reviewer to examine resumes without or greatly reduced influence of the biases that are typically inherent in the reviewer. The techniques for removing biases include, for example, having the reviewer pre-commit to the components of the resume that are most indicative of whether the candidate will be a good fit for the job and not letting one component of the resume influence what the reviewer thinks about other components of the resume. A purpose, of some embodiments, is to create a final rank order of a set of resumes that is in order of the likelihood that the job candidate will perform well in the job for which he or she is applying.

Various embodiments of the invention include a computing system configured to reduce bias in the review of resumes, the computing system comprising: a user interface configured to a human user to interact with components of job candidate resumes including reading the resume component, viewing the resume component relative to components of other resumes, and/or ranking the components of resumes relative to each other; analysis logic configured to generate a score for each resume, the score being based on the relative rankings of each component of the resume compared with other resumes; a user interface configured to display resumes being considered in an order determined by the analysis logic; storage configured to store the resumes, the rankings of the components of the resumes and logic for computing the scores associated with resumes; and a microprocessor configured to execute at least the analysis logic.

Various embodiments of the invention provide a computer-based tool for conducting interviews, phone screens, and/or reference checks for job candidates. This tool is configured to reduce the inherent bias that occurs when humans conduct these various types of interviews to determine applicable candidates for a job. The interview, phone screen, or reference check tool is configured to allow the human interviewer to perform these interviews, phone screens or reference checks without, or with greatly reduced influence of the biases that are typically inherent in the interviewer. The techniques for removing biases include, for example, ensuring that the interviewer asks either behavior-based or performance-based interview questions, ensuring that the interviewer asks the same questions of all candidates, prompting an interviewer to give specific reasons around “culture fit” or lack thereof, and creating accountability within the interview, phone screen, or reference check process. A purpose, of some embodiments, is to create a more cohesive interview, phone screen, or reference check experience for the job candidate, which can also attract the highest quality candidates to the position.

Various embodiments of the invention include a computing system configured to reduce bias in the interviewing, phone screening, and/or reference checking of candidates, the computing system comprising: a user interface configured for a human user to interact with components of job candidate interviews, phone screens, and/or reference checks including determining the questions to be used during the interview/screen/check by each interviewer, and notifying each interviewer as to the format of the interview/screen/check; a user interface configured to a human user to interact with components of job candidate interviews, phone screens, and/or reference checks including allowing each interviewer to provide feedback on the interview/screen/check of the candidate; analysis logic that looks for the use of particular phrases like “not a culture fit” and prompts the interviewer for specifics; analysis logic configured to generate a score for each interview/check/screen, the score being based on the relative rankings of answer provided by the candidate to each interviewer compared with answers provided by other candidates; a user interface configured to display feedback from interviewers on candidates; a user interface configured to display candidates being considered in an order determined by the analysis logic; storage configured to store the candidates, the rankings of the candidates and logic for computing the scores associated with candidates; and a microprocessor configured to execute at least the analysis logic.

### BRIEF DESCRIPTION OF THE DRAWINGS

FIG. 1 illustrates an human resources system, according to various embodiments of the invention.

FIG. 2 illustrates an example of a job description management module, according to various embodiments of the invention.

FIG. 3 illustrates a method of authoring a job description, according to various embodiments of the invention.

FIG. 4 is an illustration of a method of comparing job descriptions, according to various embodiments of the invention.

FIG. 5 is a block diagram illustrating a resume review module, according to various embodiments of the invention.

FIG. 6 illustrates a method of a method of providing a set of resumes to a reviewer, according to various embodiments of the invention.

FIG. 7 illustrates a method of comparing a full set of resumes with corresponding scores, according to various embodiments of the invention.

FIG. 8 is a block diagram of a candidate Interview Module, according to various embodiments of the invention.

FIG. 9 illustrates a method of entering feedback on a candidate based on a job interview, phone screen, or reference check, according to various embodiments of the invention.

FIG. 10 illustrates a method of viewing the final feedback of the interview(s), phone screen(s) or reference check(s) of a candidate or set of candidates.

FIG. 11 illustrates an authoring tool, according to various embodiments of the invention.

FIG. 12 illustrates a method of authoring a performance review, according to various embodiments of the invention.

FIG. 13 illustrates a method of viewing scores or grades that indicate the bias present in performance reviews, according to various embodiments of the invention.

### DETAILED DESCRIPTION

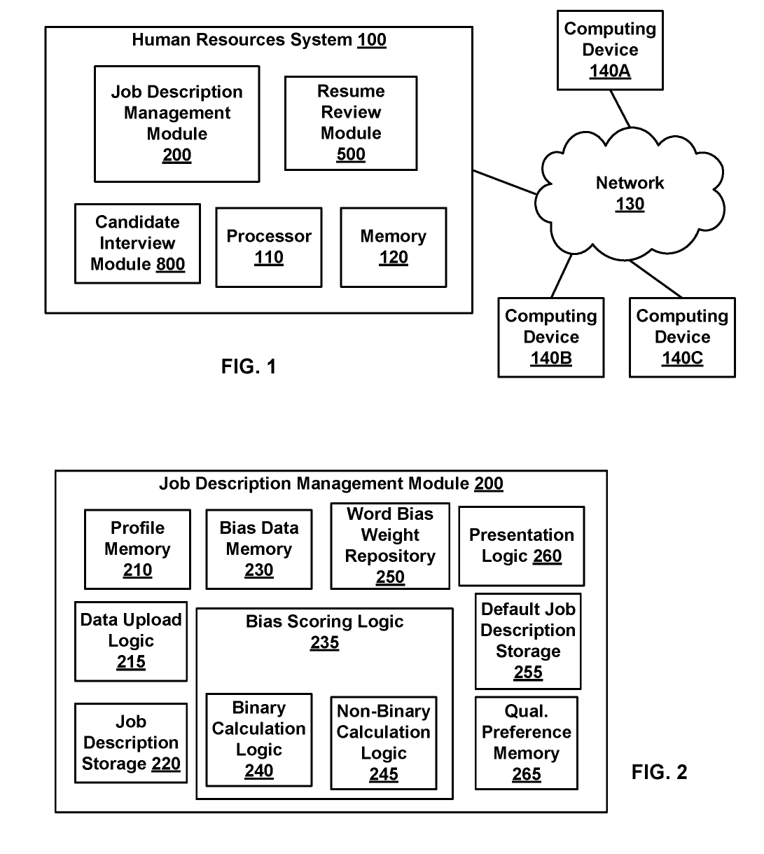

FIG. 1 is a block diagram illustrating a Human Resources System 100. Human Resources System 100 includes a Job Description Management Module 200, a Resume Review Module 500 and a Candidate Interview Module 400. Human Resource System 100 may include a personal computer, a server, a web server, a file server, a distributed computing system connected by a network, a communication device, and/or the like. Human Resources System 100 further includes at least one Processor 110 and Memory 120. Processor 110 includes a microprocessor, an ASIC, a programmable logic array, a communication circuit, a central processing unit, and/or the like. Processor 110 is typically configured to perform specific tasks by the addition of software and/or firmware. For example, Processor 110 may be configured to execute the logic discussed herein. Memory 120 may include random access memory, static memory, non-volatile memory, volatile memory, a hard drive, an optical drive, magnetic media, optical media, and/or other digital storage devices. As described elsewhere herein, Memory 120 may include data structures configured to store specific data.

The various modules included in Human Resource System 100 each consist of hardware (such as parts of Memory 120) and logic configured to perform specific functions described herein. The modules may be configured to be executed (operated) independently and/or may be integrated such that certain resources (hardware or logic) are shared. The various logical elements included in Human Resource System 100 consist of hardware, firmware, and/or software stored on a non-transient computer readable medium. For example, Human Resources System 100 can include a microprocessor specifically configured to perform the functions of Resume Review Module 500 by the addition of specific purpose software. The various logic elements included in Human Resource System 100 may be integrated or may be configured in separate, independently executable modules.

Human Resources System 100 is configured to communicate over a Network 130. Network 130 may include the internet, a wireless network, a telephone network, a computer network, a local area network, and/or the like. Optionally, Network 130 is configured for communication via IP/TCP protocols. Human Resources System 100, and the various modules therein, may be accessed using Computing Devices 140, such as a user's personal computer, cellular phone, tablet computer, telephone, or the like. Computing Devices 140 are optionally configured to execute a browser such as Internet Explorer™ or FireFox™ and communicate with Human Resources System 100 via this browser. Computing Devices 140 are optionally configured to execute an application which is specifically configured to execute on a cellular phone or other personal computing device that receives data through a cellular telephone network or a local area network. Computing Devices 140 are individually identified as Computing Device 140A, Computing Device 140B, etc.

FIG. 2 illustrates an example of Job Description Management Module 200, according to various embodiments of the invention. Job Description Management Module 200 may include a personal computer, a server, a web server, a file server, a distributed computing system connected by a network, a communication device, and/or the like. In some embodiments, Job Description Management Module 200 is configured to be accessed over Network 130 from one or more of Computing Devices 140. Job Description Management Module 200 is optionally configured to execute computing instructions using Processor 110 and/or to store data on Memory 120

Job Description Management Module 200 includes a Profile Memory 210 configured to store an author's profile (the term author is used to refer to the human author of the job description). Profile Memory 210 is optionally part of Memory 120. Profile Memory 210 may be configured to store a database of profiles associated with a plurality of authors. The author profiles include author identification information such as an author login name, an author's name, an identification number, an account name, a password, and/or the like.

The author profiles typically further include professional and/or personal information regarding the author. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education, information about the person's employment performance at this organization, results of various psychological, personality, and other tests completed by the person, the person's race and/or other information that may identify any biases that may arise from this person. One or more of the tests completed by the person are typically configured to identify biases of that person.

The information may have been entered into the Profile Memory 210 when it was provided by a human resources staff, the person or by the person's supervisor via a browser. Some embodiments of the invention include Data Upload Logic 215 configured to automatically upload profile data into Profile Memory 210. For example, Data Upload Logic 215 may be configured to automatically parse a resume, an employee history, and/or other data source and store this information in Profile Memory 210. Data Upload Logic 215 is optionally, configured to upload the data associated with one or more author profiles into Profile Memory 210.

An author profile may include information that the author was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to July 31, 2009, and Vice President of Engineering from Aug. 1, 2009 to the present. Example information that could indicate the author's bias includes, but is not limited to, where the author went to school, the ethnicity of the author, any religious affiliations of the author, any cultural or athletic affiliations of the author, indication of the author's socio-economic background, results of personality, psychological, or other tests that might indicate various types of biases, feedback from co-workers and managers, etc.

Job Description Management Module 200 further includes a Job Description Storage 220 configured to store a job description. Job Description Storage 220 is optionally part of Memory 120. Job Description Storage 220 is optionally configured to store a database of job descriptions associated with a plurality of jobs. The job profiles include job description identification information including the title of the job, the company for which the job will be associated, the organization within the company for which the job will be associated, the description of the job, the experience required to perform the job, the education required to perform the job, the soft skills required to perform the job, the nice-to-haves for potential applicants for the job, a score of the amount of bias in the job description and/or the like.

The information may have been entered into the Job Description Storage 220 when it was provided by the person responsible for creating the job description via a browser. Alternately, it may have been entered into the Job Description Storage 220 by another process. Data Upload Logic 215, is optionally further configured to upload the data associated with one or more author job descriptions into the Job Description Storage 220.

In one embodiment of the invention, after a set of job descriptions is uploaded into Job Description Storage 220 a human resources professional, company brand manager, or some set of similar people review the possible components of the job descriptions. The review process for these components is the same as described herein for a full job description where each component is reviewed on its own merit and then stored in Job Description Storage 220 for later use in creating job descriptions.

Job descriptions stored in Job Description Storage 220 are optionally grouped in job description “families.” Job description families may include job descriptions in the same company, in the same organization, having similar requirements and/or responsibilities, with the same job title, in the same company division, in the same location, or any multidimensional combination of the above.

Job Description Management Module 200 further includes Bias Data Memory 230 configured to store information about various forms of biases, various indicators of those biases, various techniques for mitigating those biases and various descriptions of the biases, and/or the reasoning behind the biases and the mechanisms for mitigating the biases. The information in Bias Data Memory 230 is optionally used by any of the modules within Human Resources System 100.

The Bias Data Memory 230 optionally contains one or more of the following: words and/or phrases that are known to be either male- or female-biased, words or phrases that indicate an age group preference, the maximum number of requirements for various components of the job description (which is configurable by the company or other entity deploying the system), components of the job description that must be included to make the job description less biased (for example, how performance is tracked or a picture of a diverse team), the fact that including at least one “soft skill” (for example, communicates well, builds great teams, etc.) can increase the number of women and minorities that apply, the fact that giving ranges of years of experience can reduce the number of qualified applicants that apply for a job, the fact that adding “or equivalent” to qualifications around experience or education can increase the number of qualified applicants for a job, etc. In the case of job descriptions, “qualifications” describes the various qualities of a candidate that are desirable for a job. Qualifications can be, but are not limited to, experience, education, technical skills, soft skills, certifications, and other such qualities. In some cases it is also desirable to avoid specific limits in a job description. “Specific limits” are, for example, requirements that a candidate be less than 30 years old or have at least 8 years of experience in a specific field.

The Bias Data Memory 230 optionally contains mitigation techniques for removing bias from a job description. Examples of a mitigation techniques include but are not limited to changing a female or male-biased term to a neutral term (for example, changing “fast paced environment” to “productive environment” or changing “aggressive” to “assertive”), adding additional female-biased terms to balance out the male-biased terms, removing terms that indicate an age preference (for example, “digital native”), adding “or equivalent” to the end of statements about experience or education, adding a “soft skill” as a qualification, adding a photograph that includes the representation of a diverse set of employees, restricting the number of requirements for various components of the job descriptions, etc.

Job Description Management Module 200 further includes Bias Scoring Logic 235 configured to parse job descriptions and to calculate a score that is the indication of the amount of bias present in the job description (a bias score). In some embodiments, Bias Scoring Logic 235 includes computer code configured to present a web interface to a user within a browser. In some embodiments, Bias Scoring Logic 235 includes computer code configured to present an interface to a person through their cellular telephone or other telecommunication device. In this case there is often an application, which is part of Job Description Management Module 200, that is used on the phone or other communication device.

Example calculations that can be performed by the Bias Scoring Logic 235 include, but are not limited to, the combination of male- or female-biased terms and the lack of a photograph depicting diverse employees. Or, having more than the maximum number of requirements in a particular section of the job description. Or, detection of a reasonable balance between the use of male and female gender oriented terms. Similarly, counting the number of education or experience qualifications that don't include the phrase “or equivalent”. Also, not including any “soft skills” as part of the required or preferred qualifications for the job. An additional example uses the potential biases of the author to increase or decrease the score based on some component of the job description. For example, if the author has a degree from Harvard, it may be scored as more biased that the requirements list that the applicant must have a degree from an Ivy League School.

In some embodiments, as a first step to building a job description, the author of the job description is asked to specify the competencies that are required for the job that will be described by the job description. Examples of competencies include, but are not limited to, technical skills (“java”, “glass blowing”, “twitter”), personal skills (“team building”, “collaboration”), experience (“has increased sales by 20%”, “has written operating systems that support multi-threading”), certifications (“certified in backhoe driving”, “certified as a CPA”), etc. Specifying competencies at the outset helps the author of the job description be specific about what is required for the job. In some embodiments, the competencies can be ranked against each other either by assigning them scores (for example, decimal numbers between 1 and 10), dragging and dropping them in relation to each other, or a multitude of other ways for ranking them. The resulting competencies and ranks of these competencies are stored in Job Description Storage 220 in association with the job to which they refer.

In some embodiments the possible content for job descriptions is created in advance, either by someone like a human resources professional writing it or job descriptions that have been written previously are parsed and stored in the system. A system of this type is similar to a content management system where the text associated with potential components of job descriptions is stored in Job Description Storage 220. As job descriptions are created from this content those job descriptions are stored. In addition as potential components of the job descriptions are modified, these new potential descriptions are also stored for future use. Storing the job description content in this manner allows human resource professionals and brand managers for a company to be sure that the job description content is appropriate and adheres to the branding requirements of the company.

An author may start with components of a job description that have been stored in the system and/or modify various components of a job description. The components of the job description can be pulled from Job Description Storage 220 for display to the author wherein the author can choose to include, exclude, or modify content for the job description being built.

The calculation of the bias score is based on the information stored in the Bias Data Memory 230 in combination with the various components of the job description. In various embodiments, there are a wide variety of methods by which a score can be calculated. In some embodiments an equation (e.g., a linear equation) is used that includes bias values multiplied by coefficients. The coefficients are based on information such as magnitude of bias per component or number of existing components that represent bias among others.

The score calculated using Bias Scoring Logic 235 is typically configured for showing the user of the system, who is the author or modifier of the job description, when their changes or additions to a job description make that job description more or less biased. The score generated by Bias Scoring Logic 235 can optionally displayed in real-time and/or be displayed based on a previous calculation. Bias Scoring Logic 235 is optionally configured to calculate a grade based on a score. A grade is a representation of a score normalized to a grading scale such as A to F, 1 to 10, one star to five stars, “Very Good” to “Very Bad,” etc.

Bias Scoring Logic 235 optionally includes Binary Calculation Logic 240 and a Non-Binary Calculation Logic 245. Binary Calculation Logic 240 is configured to calculate a score based on binary values, such as the presence of a particular words or phrases in the job description. For example, a job description may include words or phrases like “hard-core” or “best of the best” or “ninja” which have been shown to decrease female respondents to the job description. In this case, a binary score of one may be included indicating that the job description would be seen as very undesirable to females. Binary Calculation Logic 240 may use Boolean logic. Binary Calculation Logic 240 is typically used to dramatically alter scores for specific components of the job description that are preferably or absolutely to be avoided. Different factors can be weighted differently in the calculation.

Binary Calculation Logic 240 optionally includes whether or not at least one photo is included in the job description in which at least one of the photos shows diversity amongst the participants in the photo. It is shown that a photo with diverse participants can increase the female applicants to a job.

Binary Calculation Logic 240 optionally includes logic configured for determining whether or not performance objectives for the job are included in the job description. If performance objectives for the job are not included in the job description it is possible that the job will be less appealing to females.

Binary Calculation Logic 240 optionally includes logic configured for determining whether or not how performance on the job will be tracked. If how performance is tracked is included in the job description it is more likely to be of interest to some demographics, i.e., females.

Binary Calculation Logic 240 optionally includes logic configured for determining whether or not some description is given of the qualities of the best people in this role. Describing the qualities of the best people in the role—without making this a list of requirements—makes a job more attractive to women.

Binary Calculation Logic 240 is optionally configured to calculate scores based on whether the author has the possibility of being biased in any way. These calculations are based on a plethora of information in the author's profile including but not limited to the author's background, ethnicity, religion, preferences, results of psychological, personality or other tests, indications from the author's co-workers or managers, etc. This information can be used to increase or decrease the bias score based on whether or not the author is likely to have a particular bias.

Non-Binary Calculation Logic 245 is configured to calculate a score based on quantitative information within the job description. For example, the calculation of a score may include multiplying the number of skills required by a coefficient. The coefficient can be positive or negative. For example, in some circumstances a job description with more than three required skills is seen as being less desirable to female candidates. Therefore, the number of skills required beyond three may be multiplied by a coefficient and added to the bias score to indicate an increase in bias in the job description due to too many required skills.

Non-Binary Calculation Logic 245 is optionally configured to calculate scores based on whether the introductory text in the job description is “invitational”. Descriptions that are “invitational” include terms like “join” and “team” among many others. The amount of invitational text within the introductory text could be multiplied by a negative multiplier to indicate a reduction in bias in the introductory section.

Non-Binary Calculation Logic 245 is optionally configured to calculate scores based whether the job description appears to be in “lay-person” language or is more targeted towards the expert in the field. The calculation logic will include a coefficient multiplied by the amount of “expert language” detected within the job description. It has been shown that job descriptions that include language targeted towards experts are less likely to attract females.

Non-Binary Calculation Logic 245 is optionally configured to calculate scores based on the number of responsibilities listed in the job description. For example, in some circumstances, up to three responsibilities is deemed unbiased in a job description, but as additional responsibilities beyond three are added, the job becomes less desirable to females. Therefore, a coefficient may be multiplied by the number of requirements for the job beyond three requirements.

Non-Binary Calculation Logic 245 is optionally configured to calculate scores based on the number of technical skills listed as required in the job description. For example, in some circumstances, up to three technical skills required is deemed unbiased in a job description, but as additional required technical skills beyond three are added, the job becomes less desirable to females. Therefore, a coefficient may be multiplied by the number of skills required for the job beyond three skills.

Non-Binary Calculation Logic 245 is optionally configured to calculate scores based on the number qualifications listed as required in the job description. For example, in some circumstances, up to three qualifications required is deemed unbiased in a job description, but as additional qualifications beyond three are added, the job becomes less desirable to females. Therefore, a coefficient may be multiplied by the number of qualifications for the job beyond three qualifications.

Non-Binary Calculation Logic 245 is optionally configured to calculate scores based on experience listed as required in the job description. For example, in some circumstances, up to two sets of experience required is deemed unbiased in a job description, but as additional sets of experience beyond two are added, the job becomes less desirable to females. Therefore, a coefficient may be multiplied by the number of sets of experience for the job beyond two sets.

Non-Binary Calculation Logic 245 is optionally configured to calculate scores based the ranges of years included in the experience section of the job description. The larger the range of years, the less biased the job description is against female applicants. Therefore, a coefficient may be divided by the number of years in the ranges of the experience section in the job description to adjust the bias score of the job description.

Non-Binary Calculation Logic 245 is optionally configured to calculate scores based on education listed as required in the job description. For example, in some circumstances, up to two sets of education required is deemed unbiased in a job description, but as additional sets of education beyond two are added, the job becomes less desirable to females. Therefore, a coefficient may be multiplied by the number of sets of education for the job beyond two sets.

Non-Binary Calculation Logic 245 is optionally configured to calculate scores based on the number of soft skills listed as required in the job description. For example, in some circumstances, up to two soft skills required is deemed unbiased in a job description, but as additional required soft skills beyond two are added, the job becomes less desirable to females. Therefore, a coefficient may be multiplied by the number of skills required for the job beyond two skills.

Non-Binary Calculation Logic 245 is optionally configured to calculate scores based on the number of additional requirements, beyond qualifications, technical skills, education, experience, and soft skills, listed as required in the job description. Any additional requirements for a job description is seen as less desirable to female applicants, so the score will be adjusted based on the number of additional requirements added to the job description.

Non-Binary Calculation Logic 245 is optionally configured to calculate scores based on the total number of requirements listed as required in the job description. The total number of requirements in the job description can be indicative of bias in the job description.

Non-Binary Calculation Logic 245 is optionally configured to calculate scores based on the number of male- or female-biased terms used in all components of the job description. Optionally, any male- or female-biased term may have associated with it a weight where it is given that weight as a measure of the “amount of bias” associated with that term. The weights are stored in a Word Bias Weight Repository 250 and are retrieved when needed by Non-Binary Calculation Logic 145. Word Bias Weight Repository 250 optionally includes part of Memory 120 including a data structure specifically configured to store terms and associated weights. For example, research shows that the term “ninja” has a higher occurrence of discouraging women to apply than a term like “stock option” (which also discourages women, but not at the same rate). Other examples of terms that have been shown to be more discouraging to women include “competitive”, “foosball”, “beer-o-clock”. These terms might be weighted as more problematic than other terms that are also problematic but do not discourage as many women and minorities from applying.

Non-Binary Calculation Logic 245 is optionally configured to calculate scores based on the number of terms in the job description that could be seen as biased on a non-gendered basis. Examples of terms that may be considered bias that are non-gender based include but are not limited to terms that can be construed as religious (for example, “Bless you.”), terms that could be construed as cultural (for example, “Must speak English as a first language.”), terms that could be construed as being biased against certain sexual preferences (for example, “Must lead wholesome lifestyle.”), terms that could be biased by age (for example, “only digital natives need apply”), among many others.

Non-Binary Calculation Logic 245 is optionally configured to calculate scores based on whether the author has the possibility of being biased in any way. These calculations are based on a plethora of information from the author's profile including but not limited to the author's background, ethnicity, religion, preferences, results of psychological, personality or other tests, indications from the author's co-workers or managers, etc. This information can be used to increase or decrease the bias score based on whether or not the author is likely to have a particular bias.

Job Description Management Module 200 typically includes Presentation Logic 260 configured to provide scores and or grades to an author and to allow an author to make changes or additions to their job description to influence the scores of each job description. In typical embodiments, Presentation Logic 260 may be configured to generate computing instructions (e.g., graphics, html, xml, scripts, java, or the like) configured to present an interface to an author within a browser. Alternatively, Presentation Logic 260 may be configured to present information to an author via a software agent. Part of Presentation Logic 260 is optionally disposed on Computing Device 140A.

Presentation Logic 260 is typically configured to receive inputs from an author. These inputs may include text to be included in various components of the job description, photos that will be included in the job description, commands to print a job description or groups of job descriptions, customization of an author profile, the ability to save a job description, the ability to analyze a job description, the ability to indicate that a job description is ready for review by another user, the ability to post a job description to an external location such as a jobs website, the ability to send a job description to another computing system that manages job descriptions, and/or the like. For example, in some embodiments, Presentation Logic 250 is configured to present a search field to a user through a browser. The search field is configured for a user to search for a particular job description by company, organization within the company, author of the job description, title of the job description, and/or the like.

Job Description Management Module 200 optionally includes Default Job Description Storage 255 configured to store one or more default job descriptions. Default Job Description Storage 255 can include part of Memory 120 having data structures specifically configured to store job descriptions. These default job descriptions may be associated with one or job types. For example, there may be a default job description for a User Interface Software Engineer, a default job description for a Marketing Manager, a default job description for a Customer Support Agent, etc. Default job descriptions are supplied by a corporation that has many job openings of the same type.

Default Job Description Storage 255 can optionally be configured to store the various components of one or more default job descriptions. For example, it might store several possible team descriptions that are associated with the software engineering team—one description that is written from an engineer's point of view while another description is written from a product manager's point of view. Other components that might be stored in Default Job Description Storage 255 can include company descriptions, objectives, possible qualifications, education levels, experience levels, personal skills, technical skills, etc. These default job description components may be associated with one or job types. For example, there may be a default team description for an Engineering team, a default location description for a specific corporate office, a default set of skills that can be selected for a Customer Support Agent, etc.

Job Description Management Module 200 typically includes Qualification Preference Memory 265 configured to store one or more preferences associated with the qualifications identified in a job description. In some cases this Qualification Preference Memory 265 will be associated with a job description/author pair where certain authors will have preferences of qualifications for a job descriptions that may differ from preferences of other authors.

Qualification Preference Memory 265 is optionally configured to store the order of the various priority of qualifications for the job as determined by the author writing the job description. The priorities can be specified by either creating a rank order, weighting each priority (for example a weight of 10 being the highest and a weight of 0 being the lowest), or other various means of prioritizing components within the job description. For example, if the author writing the job description specifies that the required technical skills are “Java programming” and “SQL programming”, the author may store their priority of these two skills in any appropriate manner.

Qualification Preference Memory 265 is optionally configured to store the order of the priority of responsibilities in the job description. Job Preference Memory 265 is optionally configured to store the order of the priority of technical skills in the job description. Job Preference Memory 265 is optionally configured to store the order of the priority of qualifications in the job description.

Job Preference Memory 265 is optionally configured to store the order of the priority of soft skills in the job description. Job Preference Memory 265 is optionally configured to store the order of the priority of experience in the job description. Job Preference Memory 265 is optionally configured to store the order of the priority of education in the job description. Job Preference Memory 265 is optionally configured to store the order of the priority of the various components (e.g., qualifications) of the job descriptions relative to each other. For example, the author can specify the “technical skills” are of a higher priority than “education” and so on.

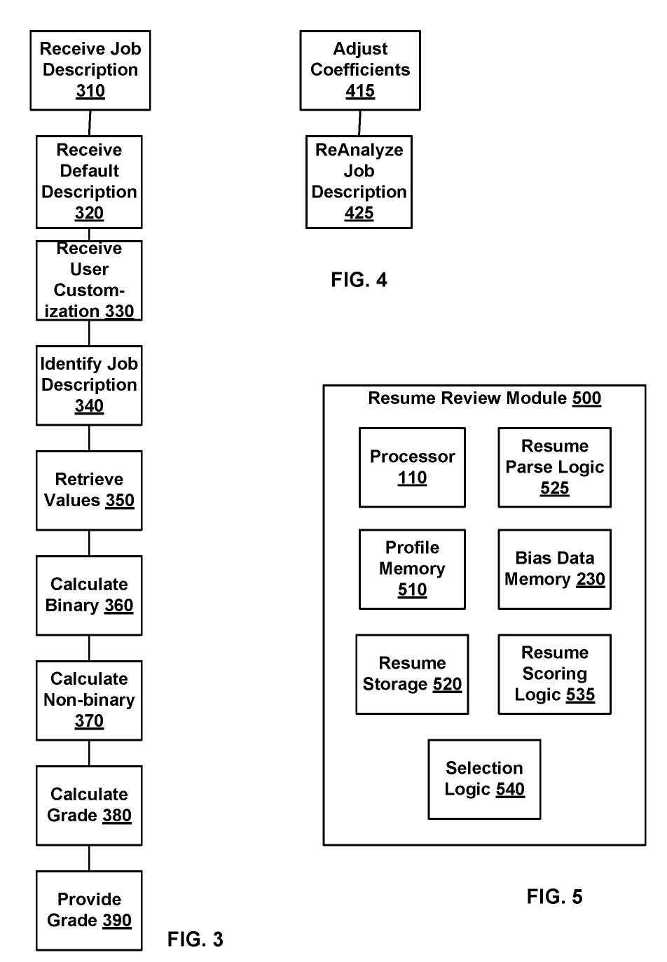

FIG. 3 is an illustration of a method of providing a grade for a job description to an author, according to various embodiments of the invention. The grade is based on various indications of potential bias in a job description as associated with the job description in question. The method illustrated in FIG. 3 is optionally performed using the Job Description Management Module 200 and can be performed in alternative step orders.

In an optional Receive Job Description Step 310 an indication of the job description to be analyzed is received by Job Description Management Module 200. This indication is optionally received via a browser or application and may include the author selecting from among a plurality of job descriptions in a menu. The received indication is optionally stored in Profile Memory 210 in association with the author.

In an optional Receive Default Job Description Step 320 one or more default job descriptions are received from Default Job Description Storage 255. The default job description is selected from among a plurality of default job descriptions stored in Default Job Description Storage 255. This selection may be based on characteristics of the job description such as the company, group within the company, title of the job, etc. As discussed elsewhere herein, the received default job description may be combined with other job descriptions, modified or enhanced, and is saved in Job Description Storage 220 as a new/altered job description.

In an optional Receive User Customization Step 330 Job Description Management Module 200 receives a customization of the default job description received in Receive Default Job Description Step 320. This customization is optionally under the approval of the author or a manager of the author. In some embodiments, the received customization may include modification of any of the qualifications or factual data associated with a particular job opportunity. The customization may be received over Network 130 from one of Computing Devices 140.

Receive Job Description Step 310, Receive Default Job Description Step 320 and/or Customization Step 330 are optional in instance where a profile for the author or a job description is already available.

In an Identify Job Description Step 340 a job description is identified. This identification may include the selection of the job description by the author from a list of job descriptions, the author providing an identifier of the job description (e.g., a job title), or the identification by Job Description Management Module 200 of job descriptions within a same category as another job description. For example, in some embodiments, Identify Job Description Step 240 includes searching Job Description Storage 220 for a job description in a specific category.

In a Retrieve Values Step 350 multiple components associated with the job description identified in Identify Job Description Step 340 are retrieved from Job Description Storage 220. This retrieval is optionally accomplished using a database query. The job description components may include the title of the job, description of the job, qualifications, requirements, and/or other information discussed herein.

In an optional Calculate Binary Step 360 a binary score for the job description identified in Identify Job Description Step 340 is calculated using Binary Calculation Logic 230. This calculation is based on the job description customized in Receive User Customization Step 330 and on one or more of the job description components retrieved in Retrieve Values Step 350. As discussed elsewhere herein, the calculation of a binary score optionally includes the use of Boolean operations.

In a Calculate Non-Binary Step 370 a non-binary score for the job description identified in Identify Job Description Step 340 is calculated using Non-Binary Calculation Logic 235. This calculation is based on the components of the job description customized in Receive User Customization Step 330 and on one or more of the job description components retrieved in Retrieve Values Step 350.

In an optional Calculate Grade Step 380 a grade is calculated from the binary score calculated in Calculate Binary Step 360 and/or the non-binary score calculated in Calculate Non-Binary Step 370. This grade is relative to a grading scale and, as such, is configured for comparison with grades calculated for other job descriptions. The calculated grade is intended to represent the amount of bias apparent in a job description. In some embodiments, the binary and non-binary scores are combined without normalization to a grade.

In a Provide Grade Step 390 the grade calculated in Calculate Grade Step 390, the binary score calculated in Calculate Binary Step 360, the non-binary score calculated in Calculate Non-Binary Step 370, and/or a combination thereof is provided to the author. This information is provided using Presentation Logic 250 and is optionally provided via Network 130 to one or more of Computing Devices 140. For example, the information may be displayed on a browser within Computing Device 140A. In some embodiments, grades or scores for multiple job descriptions are displayed together for comparison by the author. In other embodiments, a time series of grades for one or more job descriptions is displayed for the author so that the author can see the change in biases in one or more job descriptions as changes were made over time.

FIG. 4 is an illustration of a method of comparing job descriptions, according to various embodiments of the invention. In this method grades for several job descriptions are calculated and provided to an author for comparison. Also, multiple grades for the same job description can be displayed in a time-series for comparison by the author. For example, if a job description received a grade of “C” on Jan. 1 and was modified on Jan. 2 and then received a grade of “B”, a time-series chart could show the author the change to the score of the job description as changes were made. The methods illustrated by FIG. 4 are optionally performed using Job Description Management Module 200. The steps illustrated in FIG. 4 may be performed in either order.

In an optional Adjust Coefficients Step 415 coefficients used by Bias Scoring Logic 235 are adjusted based on the tolerance for various types of biases. As a result, scores for all of the job descriptions associated with those coefficients may change based on a change to the coefficients. In this embodiments, a ReAnalyze Job Description Step 425 can be run to re-analyze the job descriptions in the class for which the coefficients have been adjusted. These two steps may be performed recursively.

In ReAnalyze Job Description Step 425 being run, the previous grades of the job descriptions are stored and an additional value is stored in the Job Description Storage 220 to indicate that a change was made to the coefficients prior to this running of the grading of the job description.

Thus, in FIG. 4 when job description grades are displayed, an indication is shown to the author through the Job Description Management Module 200 that there was a change to the coefficients prior to obtaining the displayed grade.

FIG. 5 is a block diagram illustrating further details of Resume Review Module 500, according to various embodiments of the invention. Resume Review Module 500 may include a personal computer, a server, a web server, a file server, a distributed computing system connected by a network, a communication device, and/or the like. In some embodiments, Resume Review Module 500 is configured to be accessed over Network 130, for example, using Computing Devices 140. Resume Review Module 500 comprises at least one Processor 110 and Profile Memory 510 configured to store a reviewer's profile (the term “reviewer” is used to refer to the human reviewer(s) of the resume or set of resumes). Processor 110 and Profile Memory 510 are optionally shared with Job Description Management Module 200. Profile Memory 510 may include part of Memory 120 and specific data structures configured to store a user's profile. For example, Profile Memory 510 is optionally configured to store a database of profiles associated with a plurality of reviewers. The reviewer profiles include reviewer identification information such as a reviewer login name, a reviewer's name, an identification number, an account name, a password, and/or the like.

The reviewer profiles further include professional and/or personal information regarding the reviewer. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education, information about the person's employment performance at this organization, results of various psychological, personality, and other tests completed by the person, feedback or other reviews by colleagues of the person, the person's race and other information that may identify any biases that may arise from this person. One or more of the tests completed by the person are typically configured to identify biases of that person. In addition, results of past reviews by the person can be used to analyze whether or not the person is biased. For example, if the person tends to score a resume that includes “Harvard” in the education section of the resume higher than resumes that don't include the word “Harvard”, this could indicate a bias on the side of the reviewer.

The information may have been entered into the Profile Memory 510 when it was provided by the person or by the person's supervisor via a browser. The information may have been entered into the Profile Memory 210 by another process. For example, Data Upload Logic 215 is optionally configured to upload the data associated with one or more reviewer profiles into the Profile Memory 510.

For example, the reviewer profile may include information that the reviewer was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to Jul. 31, 2009, and Vice President of Engineering from Aug. 1, 2009 to the present. Additionally, the Profile Memory 510 can optionally contain information about the reviewer that would indicate potential bias by the reviewer. Example information that could indicate the reviewer's bias includes, but is not limited to, where the reviewer went to school, the ethnicity of the reviewer, any religious affiliations of the reviewer, any cultural or athletic affiliations of the reviewer, indication of the reviewer's socio-economic background, results of personality, psychological, or other tests that might indicate various types of biases, feedback from co-workers and managers, etc.

Resume Review Module 500 further includes a Resume Storage 520 configured to store a set of one or more resumes. Resume Storage 520 may include part of Memory 120 having a data structure specifically configured to store resumes. Resume Storage 520 is optionally configured to store a database of resumes associated with a plurality of job candidates. The resume profiles include resume identification information which may include, but is not limited to, the name of the candidate, the address of the candidate, the phone number of the candidate, the email address of the candidate, information about the work experience of the candidate, information about the education of the candidate, a list of skills of the candidate, and/or the like.

Resume Review Module 500 is configured for displaying the components of the resumes to the reviewer. Presentation of resumes is optionally interleaved. For example, if the reviewer needs to review 10 resumes and each resume has 6 components (experience, education, hard skills, soft skills, certifications, and interests), the Resume Review Module 500 will show each of the experience components of all 10 resumes and then show each of the education components, and after that each of the hard skills components, etc. The presentation of components from different resumes is performed in groups by component type. This process of presenting one component group at a time is referred to herein as viewing the resumes in parallel. The order of components is optionally based on the priority of the components as indicated by the reviewer. For example, if the reviewer indicated that experience is the most important component of a resume for a job, the reviewer will be shown 10 experience components as a group, without other associated components. The 10 experience components (from the 10 resumes) will be shown in random order and when the next set of components is shown (e.g., education), that set will be shown in an optionally different order. The orders are undisclosed to the reviewer. This process prevents the reviewer from associating a particular experience component with an associated education component and so on, removing the likelihood that the reviewer could see something in experience that could influence the way they view someone's education. This reduces some sources of bias in reviewing resumes.

The resume components may have been entered into the Resume Storage 520 when it was provided by the candidate via a browser. Alternately, it may have been entered into the Resume Storage 520 by another person, for example, a recruiter or a hiring manager. Alternately, it may have been entered into the Resume Storage 520 by another process. Alternatively, a substitute for the resume may be used such as a LinkedIn profile. In this case, the candidate would likely supply the Universal Resource Locator (URL) associated with the public version of their LinkedIn profile. For example the Data Upload Logic 115, is optionally further configured to upload the data associated with one or more resumes into the Resume Storage 520. Resumes are optionally stored in Resume Storage 520 in a parsed format—either through data structures or meta tags—such that the various components of the resume (like experience, education, etc.) are separate from each other but still linked to an overarching resume.

Resume Parse Logic 525, is optionally configured to parse an electronic version of a resume into its various components. Resume Parse Logic 525, will evaluate an electronic version of a resume and determine which text elements correspond to, for example, the name of the candidate, the address of the candidate, the work experience of the candidate, the education of the candidate, etc. In the case that Resume Parse Logic 525 identifies some text in the resume that cannot be categorized into a particular resume component, Resume Parse Logic 525 will request that the text be classified by a human. The possible humans that could classify the text include, but is not limited to, the candidate, the recruiter, the hiring manager, or some other person who is asked to classify the text of resumes into the various resume components. Any text that cannot be classified into a component of the resume will not be used for scoring in this process. The results of Resume Parse Logic 525 are stored in Resume Storage 520.

Resumes stored in Resume Storage 520 are optionally grouped in resume “families.” Resume families may include resumes for candidates applying for the same job, resumes for candidates applying in the same timeframe, resumes of candidates in the same geographic region, etc.

Resume Review Module 500 further includes Bias Data Memory 230, which may be shared with Job Description Management Module 200. Further examples of things that can be stored in Bias Data Memory 130 include, but are not limited to various first and last names that may indicate ethnicity, names of student and professional organizations that may indicate ethnicity (e.g., “President of the Black Students of America Group”), legal/criminal records, educational institutions that might make a reviewer favor or discard a candidate, military service record, etc.

The Bias Data Memory 230 optionally contains mitigation techniques for removing bias from the process of reviewing a resume. Examples of mitigation techniques include but are not limited to noting when the reviewer and the candidate attended the same school, noting when the reviewer is also the person who referred the candidate for the job, bias indicated by tests based on previous resume reviews by the reviewer, etc. An example of a test based on previous resume reviews by the reviewer include testing the resumes selected for interview by the reviewer compared with those not selected. Demographic information from each set of resumes (for example, gender, ethnicity, military veteran status, age, etc.) can be tested to show whether the reviewer appears to have preferences for a particular demographic group.

Resume Review Module 500 further includes Resume Scoring Logic 535 configured to calculate a score that is the indication of how well the candidate associated with the resume will perform in the job to which the candidate is applying. In some embodiments, Resume Scoring Logic 535 includes computer code configured to present a web interface to a user within a browser. In some embodiments, Resume Scoring Logic 535 includes computer code configured to present an interface to a person through their cellular telephone or other telecommunication device. In this case there is often an application that part of Resume Review Module 500 and is configured to be used on the phone or other communication device.

Example calculations that can be performed by the Resume Scoring Logic 535 include, but are not limited to, the reviewer-defined weighting of a particular component of the resume multiplied by a score given by the reviewer as to the candidate's likelihood to succeed in the position given the contents of the component of the resume, the summing of all of the weighted scores of the different components of the resume, the averaging of all of the scores given to components, the mean of all of the scores given to components, etc. As an example, consider that a resume reviewer gave the following indications of weight to the components of a resume where the first part is the resume component and the number in parentheses is the resume reviewer's weight: experience (10), technical skills (8), soft skills (5), education (5), and person who referred the candidate (4). And for a particular resume, the reviewer gave the text in the component of the resume the following scores: experience (3), technical skills (10), soft skills (4), education (9), the person who referred the candidate (9). Then one possible way to compute the score for this particular resume according to this reviewer is to multiply the weights by the scores. Namely, the overall score for the resume would be (10×3)+(8×10)+(5×4)+(5×9)+(4×9)=30+80+20+45 +36=211. Other resumes would then be scored and this final, weighted score would be computed. These weighted scores can be used to compare a set of resumes against each other. Optionally, the score can be normalized, for example to fall in the range of 1 to 100.

An additional example uses the potential biases of the reviewer to increase or decrease the score of the resume based on some component of the resume. For example, if the reviewer has a degree from Harvard, a resume where the candidate has a degree from Harvard may have its score reduced to account for the fact that the reviewer may be biased towards the graduates of Harvard.

When a reviewer begins the process of reviewing resumes, the reviewer is optionally prompted by the Resume Review Module 500 to indicate the order of importance of the components of a resume in determining whether or not a candidate will be successful in performing the job to which the candidate is applying. For example, for a particular job the experience of the job candidate may be the most indicative of whether or not the candidate will perform well in the job. For another job, the certifications achieved by the candidate may be most indicative of how well the candidate will perform in the job. The importance of the components of the resume is determined by the reviewer when that person thinks about the qualifications of a successful candidate in the particular job. In some cases this can be determined when the reviewer or author is creating the job description for the job, but it can also be determined at the time of the resume review or at other times.

Resume Review Module 500 is optionally configured to have a reviewer either manually score the various components of the resume—for example, on a scale of one to 10, having the scores of all of the components sum to a normalized value of 100, etc.—or the reviewer will put the components of the resume in order of how much the various components indicate the of likelihood of good performance of the candidate on the job. The scores, weights, or rankings associated with the components of the resume are optionally stored in Resume Storage 520.

In an optional embodiment, these rankings can be associated with the competencies identified during the creation of the job description. Resume Review Module 500 can be configured to either allow the reviewer to change the ranking of the competencies or can enforce that the rankings not be changed, depending on the scenario desired by the company.

Prompting the reviewer to rank, weight, or score the components of the resume means the reviewer is “pre-committing” to what is important for the job. Various biases have been known to come into play when a reviewer looks at a particular resume, sees the text associated with the candidate in the component of the resume and then decides, either consciously or unconsciously, that the particular component of the resume is most important to the job. By having a reviewer “pre-commit” to which resume components are most important to the job prior to the review of any resumes, it has been shown that some bias can be removed. For example, if the reviewer believes that the person who fills the job should be male, the reviewer might look for something impressive on the male candidate's resume and use that to indicate why the male is better qualified for the job. By having the reviewer “pre-commit” to what is important for the job, it has been shown that the reviewer is more likely to choose a candidate that has the best credentials for the area that was pre-committed as most important.

Once the reviewer has pre-committed to the priority of the resume components, the reviewer will be asked to rank, weight, or prioritize the text associated with these resume components. First the reviewer will be shown the text associated with the highest priority component for all of the resumes. For example, if the reviewer has seven resumes to review and has specified that “experience” is the highest priority component of the resume to determine future job success, the reviewer will be shown seven text boxes that show the text for “experience” in each of the seven resumes. The reviewer may not be shown any other components of the resume at this time. After that, the reviewer will be shown seven sets of “education” (or whichever component of the resume was said to be second most important during the pre-commitment phase). The order of the components of the resume will be randomized such that the first resume component for “experience” may correspond to a different resume than the first resume component shown for “education”.

By showing the text associated with only one component of a resume at a time, the reviewer is not able to have one part of a resume bias what the reviewer sees in another part of a resume. The usual example of this is when a name may indicate gender or race, but another place where this bias can come into play is education. Some reviewers are biased towards hiring people from Ivy League universities. These reviewers may inflate their view of candidates from these universities and/or decrease their view of resumes for candidates who did not attend Ivy League universities. By only showing one resume component at a time, reviewers are not able to allow their biases about other components of a resume influence their view of the overall resume.

Resume Review Module 500 may have the reviewer either score the various text boxes—for example, on a scale of one to 10, etc.—or the reviewer may put the text boxes from the resumes in order of how much the various components indicate the of likelihood of good performance of the candidate on the job, or the like.

The scores, weights, or rankings associated with the text of each one of the components of the resumes is optionally stored in Resume Storage 520.

In some embodiments, once the reviewer has scored or ordered the text boxes for the highest priority component of the resumes, the reviewer is shown the text of the second most important component of the resumes, and so on until all of the components of the resumes have been viewed and scored/ranked by the reviewer. The scores, weights, or rankings associated with the text of one of the components of the resumes are stored in Resume Storage 520.

In the case that some resumes have no text associated with a particular resume component, Resume Review Module 500 will display that some resumes did not include that component. For example, if two of the seven resumes being reviewed did not include any text for “Interests”, when the Resume Review Module 500 displays the text associated with “Interests”, it will include text similar to the following: “Two resumes did not include any text for ‘Interests’.”

While the reviewer is looking at particular components of the resumes, Resume Review Module 500 may or may not remind the reviewer of the predefined priority of the resume component. For example, if the reviewer specified that “Experience” is most important for success in the job in question, when the reviewer is looking at success Resume Review Module 500 may or may not have text similar to “As a reminder, you (or an author that defined the relevant job description) said that Experience was the most important component of the resume to indicating future job success.”.

Resume Scoring Logic 535 uses a calculation of the ranking score for each resume based on the information stored in the Bias Data Memory 130. In various embodiments, there are a wide variety of methods by which Resume Scoring Logic 535 can be calculated. In some embodiments Resume Scoring Logic 535 is an equation (e.g., a linear equation) that includes the sum of the priority of the various components of the resume multiplied by the score given to the particular text for the component of the resume for each component in the resume. In other embodiments of Resume Scoring Logic 535 uses other linear and non-linear equations that uses the priority or score associated with each resume component and the score or ranking associated with the text within the resume component to determine an overall score for each resume. Resume Scoring Logic 535 optionally includes binary and non-binary calculation logic such as that discussed elsewhere herein.

Optionally, once Resume Scoring Logic 535 has been used to score several or every resume in a group, Resume Review Module 500 is configured to display all of the full resumes to the reviewer in rank order using the rank determined by Resume Scoring Logic 535.

At this point, Resume Review Module 500 is configured to prompt the reviewer to categorize each resume. Possible categories of resumes include, but are not limited to: save for later, discard (archive), move to interview process, move to phone screen, move to reference check, and others. The purpose of the categorization of the resume is to determine next steps. In some cases it will be expected that there will be additional resumes to review at a future time, so some resumes may be saved for comparison with resumes that are added to the system later. When a resume is reviewed and then saved for comparison with future resumes the reviewer could either be prompted for whether they want to review the resume again in a new set of resumes or whether they just want to compare the score/ranking of the previously reviewed resume with the score/rankings of the new set of resumes.

Resume Review Module 500 optionally further includes Selection Logic 540 configured for selecting a reviewer to review one or more resumes. Selection Logic 540 is configured to select reviewers based on reviewer profiles stored in Profile memory 510 and is typically configured to select reviewers so as to minimize bias in the review. For example, a reviewer known to have a bias against candidates from certain countries would not be assigned to review resume components that are likely to indicate a country of origin. Likewise, a reviewer known to have a bias against certain schools would be avoided for the review of the Educational component of a resume.

Selection Logic 540 is optionally configured to assist a human manager in selection of a review team. For example, Selection Logic 540 may provide a list of possible reviewers ranked by the amount of bias they are likely to contribute to the review process. Such ranking may differ for different components and a reviewer may be selected to review all of a resume or one or more specific components.

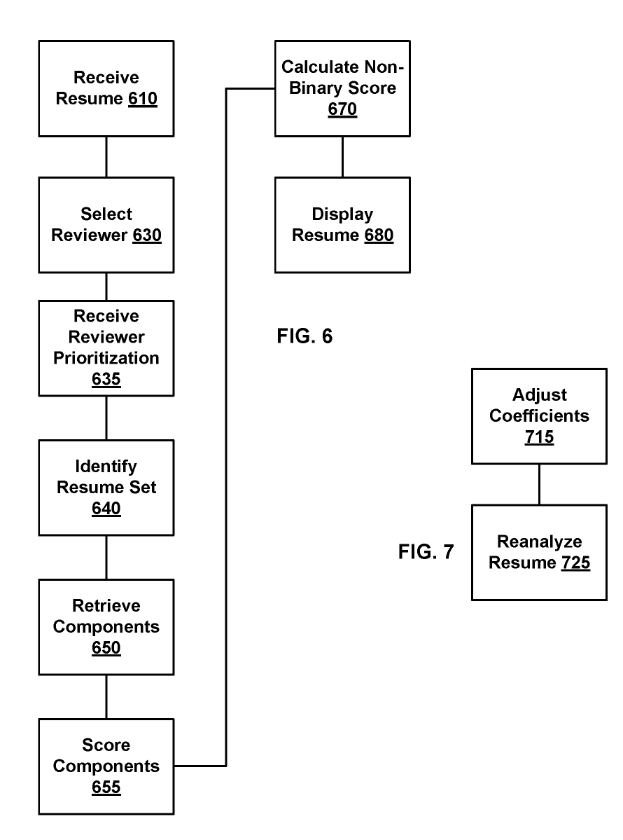

FIG. 6 is an illustration of a method of providing a set of resumes to a reviewer, according to various embodiments of the invention. In a Receive Resume Step 610 an indication of the resume to be analyzed is received by Resume Review Module 500. This indication is optionally received via a browser or application and may include the reviewer selecting from among a plurality of jobs for which they want to review resumes. The received indication is stored in Profile Memory 210 in association with a candidate and a particular job or set of jobs. Receive Resume Step 610 is optional in instances where a resume is already available.

In an optional Select Reviewer Step 630, one or more human reviewers are selected to review the resume. Reviewers may be selected to review an entire resume or one or more components thereof. For example, one reviewer may be selected to review an education component and another reviewer selected to review a technical experience component. The selection of reviewers is optionally made in consideration of any known biases of the reviewers. For example, a reviewer known to be biased against certain schools may be assigned a component other than education to review. Select Reviewer Step 630 is optionally performed using Selection Logic 540.

In an optional Receive Reviewer Prioritization Step 635, Resume Review Module 500 receives a prioritization, set of scores, or set of weights from the reviewer or a set of reviewers of the components that can be included in a resume. The prioritization may be received over Network 130 from Computing Device 140A.

In an Identify Resume Set Step 640 a set of resumes, usually associated with a particular job opening, is identified. This identification may include the selection of the set of resumes by the reviewer from a list of resumes, the reviewer providing an identifier of a job description (e.g., a job title), or the identification by Resume Review Module 500 of a set of resumes within a same category as another set of resumes. For example, in some embodiments, Identify Resume Step 640 includes searching Resume Storage 520 for a set of resumes in a specific category.

In a Retrieve Components Step 650 multiple components associated with the resume identified in Identify Resume Step 640 are retrieved from Resume Storage 520. This retrieval is optionally accomplished using a database query. The resume components may include the title of the job, description of the job, qualifications, requirements, scores associated with the text components of a particular resume, and other information discussed herein.

In a Score Components Step 655 the reviewer scores the components of the resume presented to him or her. This can be accomplished by giving them numerical scores, giving them some kind of score on a continuum (perfect for the job to not relevant to the job), ranking them in order of most qualified for the job to least qualified for the job, etc. The scoring may be facilitated by a graphically user interface generated by Resume Scoring Logic 535.

In a Calculate Score Step 670 a non-binary score for the resume identified in Identify Resume Step 640 is calculated using Resume Scoring Logic 535. This calculation is based on the components of the resume customized in Identify Resume Step 640, on one or more of the scores associated with the resume components retrieved in Retrieve Components Step 650, and on the prioritization scores or weighting identified in Receive Reviewer Prioritization Step 635.

Calculate Score Step 670 may also allow for the possibility of multiple reviewers. In the case of multiple reviewers the final score for the resume may be determined by adding the scores of the reviews of the same resume together or using some other coefficient or multiplier to get a combined score for the resume based on the scores by each reviewer for that resume.

In a Display Resume Set Step 680 the score calculated in Calculate Non-Binary Score Step 670 for each resume in the set is used to display the set of resumes to the reviewer. The text associated with each resume is displayed and the resumes are displayed in rank order as indicated by the scores calculated in Calculate Non-Binary Score Step 670. This information is provided using Presentation Logic 260 (or similar logic) and is optionally provided via Network 130 to one or more of Computing Devices 140. For example, the information may be displayed on a browser within Computing Device 140C. In some embodiments, multiple sets of resumes are shown at the same time to the reviewer. In other embodiments, a time series of scores for one or more resumes is displayed for the reviewer so that the reviewer can see the change in scores in one or more resumes as changes were made to the prioritization of components or the scores associated with the text of components of the resume or resumes over time.

In the case that multiple reviewers review the same set of resumes, Display Resume Set Step 680 allows the reviewer to see the resumes in order depending on which order is preferred. For example, the reviewer may prefer to see the resumes in order of the scores given by only that reviewer's scores. Alternatively, the reviewer may want to see the resumes in order of the scores of another reviewer. Alternatively, the reviewer may want to see the resumes in order of the combined scores of all of the reviewers or based on scores of a particular resume component. The reviewer will specify to Display Resume Set Step 680 which scores should be used when displaying the resumes.

FIG. 7 is an illustration of a method of comparing resumes, according to various embodiments of the invention. In this method the scores for several resumes are calculated and provided to a reviewer, alongside the full text of the resumes for comparison. Also, multiple scores for the same resume can be displayed in a time-series for comparison by the reviewer. For example, if a resume received a score of “70” on Jan. 1 and either the prioritization of resume components or the scores/ranking of the text associated with some set of components of the resume was modified on Jan. 2 and the resume then received a score of “78”, a time-series chart could show the reviewer the change to the score of the resume as changes were made. Time series of scores associated with a set of resumes can optionally be displayed. The methods illustrated by FIG. 3 are optionally performed using Resume Review Module 500. The steps illustrated in FIG. 3 may be performed in either order.

In an optional Adjust Coefficients Step 715 coefficients used by Resume Scoring Logic 535 are adjusted based on the tolerance for various types of biases. As a result, scores for all of the resumes associated with those coefficients may change based on a change to the coefficients. For example, if it is known that the reviewer gives more weight to resumes that include the word “Harvard”, the weight for the Education component of the resume may be reduced for that reviewer. Either separately or in addition to this adjusting of the weights, a text search could be performed on all resumes and those that contain the word “Harvard” could have their scores adjusted to account for the possible bias of the reviewer. As a contrasting example, if a reviewer is known to be biased against women, the scores for all resumes for women could be increased. In this embodiment, a ReAnalyze Resume Step 725 can be run to re-analyze the resumes in the class for which the coefficients have been adjusted.

In the case of the ReAnalyze Resume Step 725 being run, the previous scores of the resumes are optionally stored and an additional value is stored in the Resume Storage 520 to indicate that a change was made to the coefficients prior to this running of the grading of the resume. Thus, in FIG. 7 when resume scores are displayed, an indication is optionally shown to the reviewer through the Resume Review Module 500 that there was a change to the coefficients prior to obtaining the displayed score.

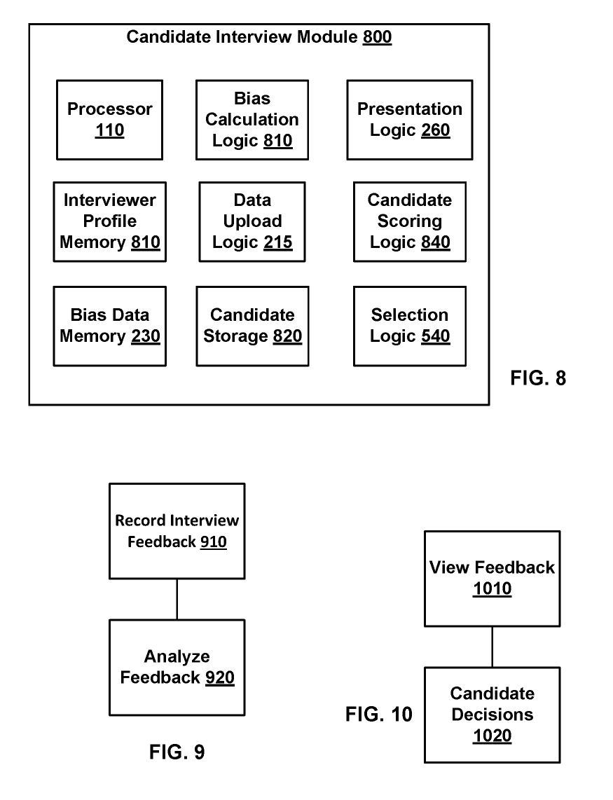

FIG. 8 is a block diagram of Candidate Interview Module 800, according to various embodiments of the invention. Candidate Interview Module 800 is, for example, a tool that can be used for conducting interviews, phone screens, reference checking, and/or the like. In some embodiments, Candidate Interview Module 800 is configured to be accessed over Network 130 using Computing Devices 140. Candidate Interview Module 800 optionally includes Processor 110 and/or logic used to program Processor 110 to perform specific tasks. Processor 110 is optionally shared with Job Description Management Module 200 and/or Resume Review Module 500.

Candidate Interview Module 800 includes an Interviewer Profile Memory 810 configured to store a set of characteristics of the interviewers of candidates. The term interviewer is used to refer to the human interviewer(s) of the candidate or set of candidates. Interviewer Profile Memory 810 is optionally configured to store a database of profiles associated with a plurality of interviewers. The interviewer profiles include interviewer identification information such as an interviewer login name, an interviewer's name, an identification number, an account name, a password, and/or the like. Interviewer Profile Memory 810 optionally includes part of Memory 120 including data structures specifically configured to store interview profiles.

The interviewer profiles further include professional and/or personal information regarding the interviewer. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education (e.g., schools attended and/or degrees earned), information about the person's employment performance at this organization, results of various psychological, personality, and other tests completed by the person, feedback or other reviews by colleagues of the person, the person's race, place of birth, citizenship and/or cultural heritage, and any other information that may identify any biases that may arise from this person. One or more of the tests completed by the person are typically configured to identify biases of that person. In addition, results of past interviews conducted by the person can be used to analyze whether or not the person is biased. For example, if the person tends to score a candidate that attended Harvard higher than candidates that didn't attend Harvard, this could indicate a bias on the part of the interviewer.

The information about an interviewer may have been entered into Interviewer Profile Memory 810 when it was provided by the person or by the person's supervisor via a browser. Optionally, this information may be garnered from tests taken by the interviewer to determine various types of bias the interviewer may have. The information may have been entered into Interviewer Profile Memory 810 by another process. For example, Data Upload Logic 215 is optionally configured to upload the data associated with one or more interviewer profiles into Interviewer Profile Memory 810.

The interviewer profile may include information that the interviewer was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to Jul. 31, 2009, and Vice President of Engineering from Aug. 1, 2009 to the present. Additionally, Interviewer Profile Memory 810 can optionally contain information about the interviewer that would indicate potential bias by the interviewer. Example information that could indicate the interviewer's bias includes, but is not limited to, where the interviewer went to school, the ethnicity of the interviewer, any religious affiliations of the interviewer, any cultural or athletic affiliations of the interviewer, indication of the interviewer's socio-economic background, results of personality, psychological, or other tests that might indicate various types of biases, feedback from co-workers and managers, etc.

Candidate Interview Module 800 further includes a Candidate Storage 820 configured to store a set of profiles of one or more candidates associated with a set of job openings. Candidate Storage 820 may include part of Memory 120 having a data structure specifically configured to store candidate profiles. The candidate profiles include candidate identification information such as the candidate's name, an identification number, physical address, email address, phone number, and/or the like. Additionally, the candidate profiles include resume information for the candidate including, but not limited to, information about the candidate's experience, education, skills, certification and/or the like.

Additionally, candidate profiles can include demographic and other information such as gender, race, nationality, sexual preference, veteran status, handicap status, and/or other information, which may induce biases from interviewers. Additionally, candidate profiles can include results of various psychological, personality, and other tests completed by the candidate.

Candidate Storage 820 is optionally configured to store a database of resumes associated with a plurality of job candidates. The resume profiles include resume identification information which may include, but is not limited to, the name of the candidate, the address of the candidate, the phone number of the candidate, the email address of the candidate, information about the work experience of the candidate, information about the education of the candidate, a list of skills of the candidate, and/or the like. Optionally, resume scores for one or more specific job opportunity is stored as part of a candidate profile.

The information about a candidate may have been entered into the Candidate Storage 820 when it was provided by the candidate by inputting their resume or portions of their resume via a browser or when it was received by a recruiter or hiring manager via a browser. The information may have been entered into the Candidate Storage 120 by another process. For example, Data Upload Logic 215 is optionally configured to upload the data associated with one or more candidate profiles into the Candidate Storage 820. This data may be parsed from resumes.

Candidate Interview Module 800 further includes Bias Data Memory 230 configured to store information about various forms of biases, various indicators of those biases, various techniques for mitigating those biases and various descriptions of the biases, and/or the reasoning behind the biases and the mechanisms for mitigating the biases in interviews. Further examples of things that can be stored in the Bias Data Memory 230 include terms that are often used to indicate that female candidates are not acceptable for a job and similar terms. Bias Data Memory 230 is optionally shared with Job Description Management Module 200 and/or Resume Review Module 500.

The Bias Data Memory 230 optionally contains mitigation techniques for removing bias from the processes of conducting interviews, performing phone screens, and checking references. Examples of mitigation techniques include but are not limited to noting when the interviewer and the candidate attended the same school, noting when the interviewer is also the person who referred the candidate for the job, bias indicated by tests based on previous interviews by the interviewer, an indication that an interviewer didn't spend enough time on particular questions with the candidate, terms in the interview feedback like “not a culture fit” or other problematic text, etc.

Candidate Interview Module 800 is configured to display a set of candidates being considered for a particular job opening. A hiring manager (e.g., the person ultimately responsible for making the hiring decision about a particular job opening) can view the set of candidates and determine the next step for determining which candidate is the best fit for the job opening. Possible next steps include, but are not limited to: conducting an onsite interview, conducting a phone screen, or conducting reference checks. The hiring manager indicates to Candidate Interview Module 800 which next step the hiring manager wants to take for a particular job opening and, at that point, Candidate Interview Module 800 walks the hiring manager through the steps to perform the specified function.

The steps that may be performed using Candidate Interview Module 800, for interviewing, phone screens, and reference checking are similar. For example, in some embodiments, when a hiring manager indicates that he or she wants to conduct an onsite interview, Candidate Interview Module 800 prompts the hiring manager to select the set of one or more candidates to be interviewed. In addition, Candidate Interview Module 800 prompts the hiring manager to indicate the interviewers to be included in interviewing the selected set of candidates.

Candidate Interview Module 800 is optionally configured to prompt the hiring manager to determine the set of questions to be asked of each candidate. Research indicates that the best types of questions to ask candidates are behavior-based questions or performance-based questions. Candidate Interview Module 800 provides a set of behavior-based interview questions and/or a set of performance-based interview questions to the hiring manager so that the hiring manager can select which of these questions he or she wants the interviewers to ask the candidates. The questions presented to the hiring manager can, but do not have to, be based on any of the following: the competencies specified at the time the job description was written, the information in the job description, information recorded about priorities of qualifications or other items in the job description, information about which qualifications were indicated as most important in the resume review process, scores of resumes of candidates in the resume review process (including, but not limited to, specific qualifications on particular resumes that received low scores in the resume review process), information provided by the candidate via the resume, feedback recorded during a phone screen interview, etc.

The questions presented to the hiring manager can, but do not have to be, reviewed by someone in human resources or the legal team to determine whether or not they are in compliance with appropriate laws, policies of the company, branding associated with the company, identification of questions that may be biased (for example, “do you plan to have children soon?”), etc.

In addition, the hiring manager can enter their own questions they want the interviewers to ask the candidates. In the case that hiring managers enter their own questions, Bias Calculation Logic 810 can be used to determine if any of the questions entered by the hiring manager contain indications of bias. Possible indications of bias could include, but are not limited to, asking about sports, asking about specific schools or educational background, asking questions related to anything that was indicated as a specific bias of the interviewer in the Profile Memory 210. In the case that bias is suspected, several possible actions can be taken. These actions include, but are not limited to notifying the hiring manager that the question may be biased, recommending to the hiring manager that the biased question be changed, recording that a biased question has been included, notifying a supervisor, recruiter or other individual that a biased question has been included, and/or not allowing the hiring manager to use that question as part of the Candidate Interview Module 800. In addition, Bias Calculation Logic 810 can optionally suggest to the hiring manager particular questions for particular interviewers based on any bias indicated for an interviewer. For example, if it is known that a particular interviewer prefers candidates that completed their education degrees from Harvard, Bias Calculation Logic 810 could indicate to the hiring manager that the particular interviewer should not ask the candidates about their educational backgrounds.

In some embodiments, the hiring manager may assign a “competency” for the interviewer to explore. These competencies are skills or qualifications that are important for the job. Examples of competencies include, but are not limited to, “Java skills”, “ability to build teams”, “good rapport with customers”, etc. Interviewers are then tasked with determining the proficiency of the candidate in these competencies, but are free to determine the best way to assess the competency for the candidate.

Once the set of candidates has been identified, the interviewers have been identified, and the set of questions to be used during the interview have been identified, Candidate Interview Module 800 prompts the hiring manager to assign a set of interview questions to each interviewer. Each of the questions that have been identified for use during the interview will be assigned to one or more interviewer to be asked. In some embodiments, to avoid the possibility of bias, each interviewer asks the same set of questions to each candidate. For example, Interviewer A will ask all candidates Questions 1A, 2A, and 3A as assigned by the hiring manager and Interviewer B will ask all candidates Questions 1B and 2B as assigned by the hiring manager. If Interviewer A asks Candidate 1 about Question 1A and records a response, then having Interviewer B ask Candidate 2 about Question 1A and recording the result may create a discrepancy between the quality of responses to Question 1A. By ensuring that the same interviewer asks the same questions and records responses it is more likely that there will be consistency across the way candidates are judged. Alternatively, interviewers can be assigned competencies to evaluate instead of specific questions. Alternatively, interviewers can be assigned a combination of interview questions and competencies.

The candidate identification step, interviewer identification step, and question determination step can be carried out in any order.

Once the questions have been assigned to each interviewer, Candidate Interview Module 800 prompts the hiring manager to schedule the interviews for each candidate. Assistance in scheduling the interviews can be accomplished through the Candidate Interview Module 800 or through some other tool such as Microsoft Outlook™ or another tool.

Optionally, once the interviews have been scheduled, Candidate Interview Module 800 records the date and time for each interview. At some point before the interview occurs, Candidate Interview Module 800 can notify the interviewer of the upcoming interview and provide information that explains the questions to be asked by the interviewer of each candidate. Alternatively, the hiring manager can be provided a Universal Resource Locator that takes the interviewer to a webpage that explains the process of the interview. The Universal Resource Locator can be included in a calendar invite for the interviewer for convenient access. The web page where the interviewer receives information about the interview may or may not be password protected. An electronic or paper template can be provided to each interviewer that facilitates the interviewer conducting the interview in the way specified by the hiring manager. This template could include, but is not limited to, a script for explaining to the candidate how the interview will progress, suggested interview questions, the resume of the candidate, prose from the hiring manager of specific things to look for in the candidate, the date and time of the interview, recommendations for how to conduct an unbiased interview, information about biases that are known for the interviewer to make him or her aware of his or her biases, etc.

A similar process to the one described for coordinating interviews is carried out when a hiring manager wants to perform a phone screen or a set of phone screens. In the case of a phone screen Candidate Interview Module 800 prompts the hiring manager to select the set of candidates to be screened, determine the person or set of people who will perform the phone screen and establish the set of questions to be used by those people during the phone screen. Questions used for phone screens should also be either behavior-based or performance-based or meant to assess competencies. Once the phone screen has been scheduled, Candidate Interview Module 800 notifies the people performing the phone screen as to the format of the phone screen similar to the way Candidate Interview Module 800 notified interviewers of the format of the interview prior to the date and time of the interview. Alternatively, electronic calendar invitations can be created and a Universal Resource Locator can be put into such calendar invitations. Creating consistency across phone screens helps to mitigate the impact of biases in the same way it for candidate interviews.

A similar process to the one described for coordinating interviews is carried out when a hiring manager wants to perform a reference check or a set of reference checks. In the case of reference checks Candidate Interview Module 800 prompts the hiring manager to select the set of candidates to be checked, determine the person or set of people who will perform the reference check and establish the set of questions to be used by those people during the reference check. Questions used for reference checks should also be either behavior-based or performance based checking the behavior or the performance of the candidate or meant to assess competencies. The questions suggested and/or chosen to be asked could correspond to the type of reference to be checked. For example, there may be a set of questions that are appropriate to be asked of a former employer and another set of questions that are appropriate to be asked of a teacher, etc. Once the reference check has been scheduled, Candidate Interview Module 800 notifies the people performing the reference check as to the format of the reference check similar to the way Candidate Interview Module 800 notified interviewers of the format of the interview prior to the date and time of the interview. Alternatively, electronic calendar invitations can be created and a Universal Resource Locator can be put into such calendar invitations. Creating consistency across phone screens helps to mitigate the impact of biases in the same way it does for candidate interviews.

FIG. 9 is an illustration of a method of providing feedback on a candidate based on a job interview, phone screen or reference check, according to various embodiments of the invention. The feedback includes, for example, the interviewers impressions of answers provided by the candidate or written answers, in response interview questions. In a Record Interview Feedback Step 910 the interviewer is presented with the questions that have been assigned to him or her. These questions may optionally be accessed using Computing Devices 140 via Network 130 or via a printout of the format of the interview.

The set of questions to be asked is identified by Candidate Interview Module 800 as the set of questions assigned to the interviewer who is accessing the system. These questions are presented to the interviewer and the interviewer presents these questions to the candidate as part of the interview. In addition, the interviewer is optionally reminded that it is helpful to ask candidates the same questions and score candidates on the same standards. In addition, the interviewer is optionally reminded of any biases that he or she may have based on the information stored in Bias Data Memory 230. In addition, the interviewer is optionally reminded that their feedback may become public to some subset of the set of interviewers for this candidate, the hiring manager, and recruiters or human resources professionals at the interviewer's organization. Reminding the interviewer that the feedback can become public tends to reduce the occurrence of irrelevant reasoning being used to reject a candidate for a job.

Candidate Interview Module 800, via logic similar to Presentation Logic 260, is configured to provide the interviewer an interface, often via a browser or mobile device, which allows the interviewer to record feedback about the candidate and the candidate's responses to the interview questions. This feedback is optionally in the form of prose. Optionally the interviewer can also assign a score to the candidate's response or record some other indication as to how well the candidate addressed each interview question. Scores can be numerical, on an A through F level or a multitude of other indications as to the proficiency of the candidate's response to the interview question(s). In some embodiments, the interviewer is shown a minimum number of characters that should be entered for feedback on the candidate for each interview question. This encourages the candidate to ensure that they are being thorough in exploring the particular question with each candidate. In some embodiments, the time the interviewer spends on each question is recorded a part of Memory 120 including a data structure specifically configured to store this data. The time spent on each question can be computed by determining the time between when the interviewer clicks in the feedback box for one interview question and the feedback box for the next interview question. Recording the time spent on each question, and later displaying that time, encourages interviewers to spend significant time on each interview question.

The interviewer can either record their feedback in real-time as the candidate is responding to the question or questions or the interviewer can record their feedback following the interview.

When the interviewer enters their feedback into Candidate Interview Module 800, the system optionally requires the interviewer to enter a response for every interview question. It is helpful that interviewers ask candidates as many of the same questions as possible, thus in some embodiments, Analyze Feedback Step 920 enforces that the interviewer must have a response to every required question for every candidate by checking feedback as it is entered into the system to confirm that some feedback has been entered by the interviewer for the candidate for each interview question or competency being evaluated. Optionally, hiring managers or phone screeners may add their own questions or competencies to the interview. In this case, logic similar to Presentation Logic 260 allows the entry of new questions/competencies and these are optionally stored in a part of Memory 120 including a data structure specifically configured to store this data.

While the interviewer is entering their feedback into Candidate Interview Module 800, the system optionally reminds the interviewer of potential biases that the interviewer possesses based on the information stored in Bias Data Memory 230. In addition, while the interviewer is entering their feedback into Candidate Interview Module 800, the system will optionally remind the interviewer that his or her feedback can be made available to a recruiter, hiring manager, and other interviewers. When the interviewer knows that their feedback may be visible to other interviewers, research has shown that providing visibility and, therefore, accountability of the feedback entered by multiple interviewers tends to reduce the occurrence of interviewers giving a candidate a poor review due to something that is not relevant to whether or not the candidate can perform their job.

Optionally, for each candidate or for each question per candidate, Candidate Interview Module 800 will ask each interviewer to score the candidate. Scores can be numerical values, A-F grades, or some other methodology for indicating the likelihood that the candidate will perform well at the job being considered.

Either as the interviewer enters their feedback or after the feedback has been entered in Record Interview Feedback Step 910, Candidate Interview Module 800 uses Analyze Feedback Step 920 to optionally analyze the words used in the feedback to determine if any bias exists. Information from the Bias Data Memory 230 is used by Analyze Feedback Step 920 to determine if some bias may or may not exist in the feedback associated with the candidate's interview. The determination of bias made by Analyze Feedback Step 920 can be binary, indicating that bias exists, on a spectrum, giving a score of how much bias exists, or presented in some other way to notify some set of the interviewer, the other interviewers, the hiring manager, the recruiter or recruiters involved or other human resources professionals from the organization about possible biases. For example, using terms like “not a culture fit” can be an indication of bias as this phrase has been associated with interviewers' desire to not hire someone without providing a concrete reason for the hire. Additionally, words like “emotional” or “personality” tend to be used detrimentally against women candidates more frequently than against male candidates. Occurrences of these types of words might be counted or the binary indication of the occurrence of these words might be shown or other algorithms might be used to compute a score or an indication of bias. These calculations may be performed using logic similar to or identical to Bias Scoring Logic 235 and included in Candidate Interview Module 800. This logic is configured to perform calculations such as those discussed with respect to Bias Scoring Logic 235, except that the calculation is used to calculate scores for interview questions and/or the analysis of responses. This logic may include embodiments of Binary Calculation Logic 240 and/or Non-Binary Calculation Logic 245, configured for interview analysis.

In some embodiments, candidate Interview Module 800 uses the date and time of the interview to determine when an interviewer has completed an interview but has not yet entered feedback about the interview. Candidate Interview Module 800 is configured to remind the interviewer, through email, text message, mobile alert, desktop alert, or some other alerting mechanism, to enter their feedback about an interview into Candidate Interview Module 800.

Some embodiments of Candidate Interview Module 800 include a version of Selection Logic 840 configured to select interviewers. This selection may be similar to that of the selection of resume reviewers discussed elsewhere herein. Specifically, Selection Logic 540 may use interviewer profiles stored in Interviewer Profile Memory 810 to facilitate the selection of interviewers so as to reduce or minimize the inherent human bias in an interview. An interviewer suspected of having bias in one area may be assigned interview questions that avoid that area.

Some embodiments of Candidate Interview Module 800 include Candidate Scoring Logic 840 (FIG. 8) that uses the feedback given by each of the interviewers to determine a final score for the candidate. Candidate Scoring Logic 840 can perform linear or non-linear calculations to determine a final score for each candidate based on the scores given to the candidate or to each question asked of the candidate by the interviewers. An example of a non-linear calculation could be a weighted average of the scores based on an indication of the hiring manager of how important each question is to the indication of whether or not the candidate will perform well in the job.

Candidate Interview Module 800 typically includes an embodiment of Presentation Logic 260 configured to facilitate the interview process. This embodiment of Presentation Logic 260 can include, for example, logic configured to generate a first user interface configured for a human user to interact with components of job candidate interviews including determining the questions to be used during the interviews by each interviewer. These embodiments may also include logic configured to generate a second user interface configured for a human user to interact with components of job candidate interviews including allowing each interviewer to provide feedback on the interview of the candidate.

A similar process to the one described for entering feedback about interviews is carried out when a hiring manager or phone screener assigned by the hiring manager wants to perform a phone screen or a set of phone screens. In the case of a phone screen Candidate Interview Module 800 prompts the hiring manager or phone screener with each question to be asked of each candidate during the phone screen process. Candidate Interview Module 800 optionally reminds the hiring manager or phone screener that candidates must be asked the same or similar set of questions or evaluate the same or similar set of competencies during the phone screen. Optionally, hiring managers or phone screeners may add their own questions or competencies to the interview. In this case, Presentation Logic 260 allows the entry of new questions/competencies. The hiring manager or phone screener then enters answers and feedback about the candidate into Candidate Interview Module 800. Indication of bias, obtained from Bias Data Memory 230, is optionally used to notify the hiring manager or phone screener about potential bias in the answers and/or feedback recorded in Candidate Interview Module 800. The indication of bias can be shown in real-time or could be determined after the fact.

A similar process to the one described for entering feedback about interviews is carried out when a hiring manager or reference checker assigned by the hiring manager wants to perform a reference check or a set of reference checks. In the case of a reference check Candidate Interview Module 800 prompts the hiring manager or reference checker with each question to be asked of each candidates' reference during the reference check process. Candidate Interview Module 800 optionally reminds the hiring manager or reference checker that candidates should be asked many of the same questions during the reference check. Optionally, hiring managers or phone screeners may add their own questions or competencies to the interview. In this case, Presentation Logic 260 allows the entry of new questions/competencies. The hiring manager or phone screener then enters answers and feedback about the reference check into Candidate Interview Module 800. Indication of bias, obtained from Bias Data Memory 230, is optionally used to notify the hiring manager or phone screener about potential bias in the answers and/or feedback recorded in Candidate Interview Module 800. The indication of bias can be shown in real-time or could be determined after the fact.

FIG. 10 is an illustration of how Candidate Interview Module 800 is used by the hiring manager, recruiter, or other interviewers to view the feedback about a candidate interview, phone screen, or reference check. In the case of a candidate interview, the answers and feedback recorded by all or several of the interviewers of the candidate can be viewed through Candidate Interview Module 800 via View Feedback Step 1010. Optionally, if Candidate Scoring Logic 840 was used to compute a score for each candidate, the candidates can be shown in order of the final score given to them. Optionally, if timing for each interview question has been recorded, this information can be shown as part of the feedback given by each interviewer. Once the feedback from all interviewers has been entered, the recruiter and the hiring manager receive an email from Candidate Interview Module 800 notifying them that all feedback has been received. The recruiter and the hiring manager can check at any time via View Feedback Step 1010 to see which interviewers have entered their feedback and which interviewers still need to enter their feedback. The feedback can include answers to specific questions, ratings by the interviewer for each answer, a summary of an interview, and/or the like.

The recruiter can see the feedback of any interviews that have been conducted at any time via View Feedback Step 1010. The hiring manager and other interviewers can see the feedback of any interview that has been conducted only after the hiring manager or interviewer has entered their own feedback into the system.

Once the hiring manager has reviewed all of the feedback of the interviewers via View Feedback Step 1010, the hiring manager will be prompted to determine whether they want to move forward with a particular candidate. Candidate Interview Module 800 will record the hiring manager's decision for each candidate via a Record Candidate Decisions Step 1020 and will optionally send out a notification to some set of the recruiter, the interviewers, and the candidates about the decision made about the candidate.

Possible decisions about candidates can include, but are not limited to, “hire”, “hold until other candidates have been interviewed”, “hold until other candidates have been phone screened”, “hold until other candidates have had their references checked”, “no longer consider for this position”, etc. Candidate Interview Module 800 can take a multitude of appropriate actions depending on the decision of the hiring manager. Some of this actions can include, but or not limited to, notifying the recruiter of the decision, sending notification to the candidate, sending notification to the other interviewers, initiating a process within the organization's human resources systems to hire the candidate, etc.

A similar process to the one described for reviewing interview feedback is also used for reviewing feedback on both phone screens and reference checks.

Several embodiments are specifically illustrated and/or described herein. However, it will be appreciated that modifications and variations are covered by the above teachings and within the scope of the appended claims without departing from the spirit and intended scope thereof. For example, while part of the current disclosure is directed at job descriptions, alternative embodiments of the invention may be applied to other organizational products such as company marketing materials, promotional advertisements, and other human resource-related documents. While part of the current disclosure is directed at resumes, in alternative embodiments of the invention the same systems and method used for resumes may be applied to other organizational functions such as candidate interviews, phone screens, and any other interactions with candidates. While the current disclosure is directed at interviews, phone screens, and reference checks, alternative embodiments of the invention may be applied to other organizational products including promotions or other interactions with job candidates or promotion candidates. The systems and methods disclosed herein may be applied to other types of applications such as grant applications, school/college applications, bid solicitation, etc.

The various examples of logic noted above can comprise hardware, firmware, or software stored on a computer-readable medium, or combinations thereof. This logic may be implemented in an electronic device to produce a special purpose computing system. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

Various embodiments of the invention provide a computer based performance review authoring tool configured to reduce the inherent bias that is often found in performance reviews prepared by human authors. The authoring tool is configured to guide a human author in the preparation of performance reviews. This guidance includes, for example, crafting of language having reduced bias, scoring language for bias content, providing suggestions for language including less bias, and prompting the author to consider several aspects of performance for all employees. A purpose, of some embodiments, is to generate performance reviews that include less bias than performance reviews that would typically be generated by a human author alone. It has been shown that other mechanisms, for example training, that attempt to remove this bias have been ineffective. Therefore, a programmatic approach is necessary. The use of a computer eliminates or substantially reduces biases that would be inherent to humans performing similar functions.

Various embodiments of the invention include a computing system configured to reduce bias in the authoring of self-performance reviews, the computing system comprising: a user interface configured to a human user to enter words of a performance review of themselves; a user interface configured to remind the reviewer of the attributes that are relevant to the performance of an individual in the job; a rule base comprising a plurality of rules for the content of a performance review, the plurality of rules including a rule to avoid specific terms in the performance review, a rule to encourage the use of specific terms in the performance review, a rule to encourage the accomplishment of “household tasks” at the office (taking notes in meetings, mentoring, organizing parties), and a rule to have reviewers consider both performance and potential when writing a performance review of ones self; analysis logic configured to generate a score for the self-performance review, the score being based on compliance of the self-performance review to the plurality of rules; storage configured to store the performance review and the plurality of rules; and a microprocessor configured to execute at least the analysis logic.

Various embodiments of the invention include a computing system configured to reduce bias in the authoring of performance reviews, the computing system comprising: a user interface configured to a human user to prompt the human user to describe several positive aspects of the reviewee using specific job-relevant questions; a user interface configured to a human user to prompt the human user to describe several negative aspects of the reviewee using specific job-relevant questions; a user interface configured to a human user to enter words of a performance review; a user interface configured to remind the reviewer of the attributes that are relevant to the performance of an individual in the job; a rule base comprising a plurality of rules for the content of a performance review, the plurality of rules including at least two of: a rule to avoid specific terms in the performance review, a rule to encourage the use of specific terms in the performance review, a rule to encourage the accomplishment of “household tasks” at the office (taking notes in meetings, mentoring, organizing parties) and a rule to have reviewers consider both performance and potential when writing a performance review; analysis logic configured to generate a score for the performance review, the score being based on compliance of the performance review to the plurality of rules; storage configured to store the performance review and the plurality of rules; and a microprocessor configured to execute at least the analysis logic.

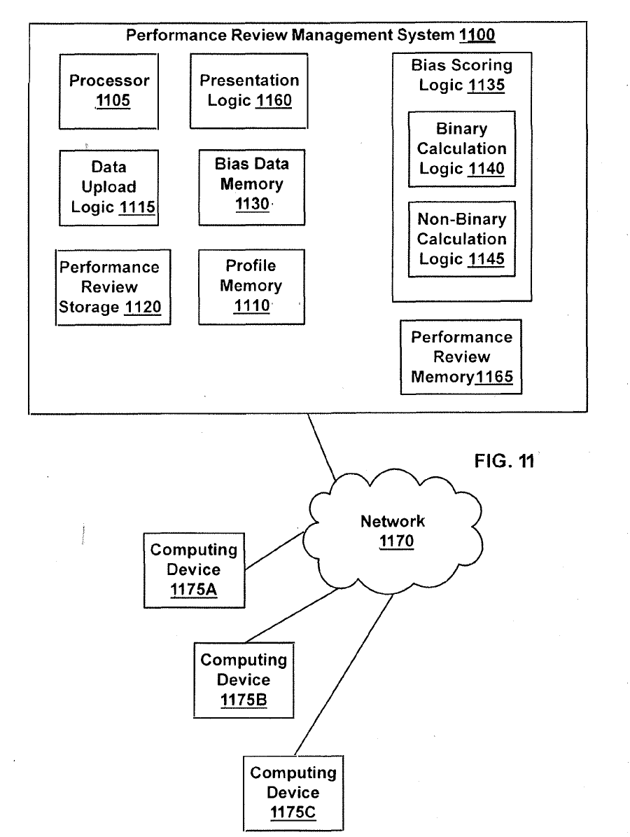

FIG. 11 is a block diagram illustrating a Performance Review Management System 1100, according to various embodiments of the invention. Performance Review Management System 1100 may include a personal computer, a server, a web server, a file server, a distributed computing system connected by a network, a communication device, and/or the like. In some embodiments Performance Review Management System 1100 is configured to be accessed over a Network 1170. Network 1170 may be the internet, a telephone network, a computer network, a local area network, and/or the like. Optionally, Network 1170 is configured for communication via IP/TCP protocols. Performance Review Management System 1100 may be accessed using Computing Devices 1175, such as a user's personal computer, cellular phone, tablet computer, telephone, or the like. Computing Devices 1175 are optionally configured to execute a browser such as Internet Explorer™ or FireFox™ and communicate with Performance Review Management System 1100 via this browser. Computing Devices 1175 are optionally configured to execute an application which is specifically configured to execute on a cellular phone or other personal computing device that receives data through a cellular telephone network or a local area network. Computing Devices 1175 are individually identified as Computing Device 1175A, Computing Device 1175B, etc.

Performance Review Management System 1100 comprises at least one Processor 1105. Processor 1105 includes a microprocessor, an ASIC, a programmable logic array, a communication circuit, a central processing unit, and/or the like. Processor 1105 is typically configured to perform specific tasks by the addition of software and/or firmware. For example, Processor 1105 may be configured to execute the logic discussed herein.

Performance Review Management System 1100 further includes a Profile Memory 1110 configured to store an author's profile. As used herein, the term “author” is used to refer to the human author of the performance review. Profile Memory 1110 may include random access memory, static memory, non-volatile memory, volatile memory, a hard drive, an optical drive, magnetic media, optical media, and/or other digital storage devices. Profile Memory 1110 is optionally configured to store a database of profiles associated with a plurality of authors. The author profiles include author identification information such as an author login name, an author's name, an identification number, an account name, a password, and/or the like. Typically Profile Memory 1110 includes a data structured specifically configured to store this information.

The author profiles further include professional and/or personal information regarding the author. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education, information about the person's employment performance at this organization, results of various psychological, personality, and other tests completed by the person, the person's race and other information that may identify any biases that may arise from this person. One or more of the tests completed by the person are typically configured to identify biases of that person.

The information may have been entered into the Profile Memory 1110 when it was provided by the person or by the person's supervisor via a browser. The information may have been entered into the Profile Memory 1110 by another process, the Data Upload Logic 1115, configured to upload the data associated with one or more author profiles into the Profile Memory 1110.

For example, the author profile may include information that the author was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to Jul. 31, 2009, and Vice President of Engineering from Aug. 1, 2009 to the present. Additionally, the Profile Memory 1110 can optionally contain information about the author that would indicate potential bias by the author. Example information that could indicate the author's bias includes, but is not limited to where the author went to school, the ethnicity of the author, any religious affiliations of the author, any cultural or athletic affiliations of the author, indication of the author's socio-economic background, results of personality, psychological, or other tests that might indicate various types of biases, feedback from co-workers and managers, etc.

Performance Review Management System 1100 further includes a Performance Review Storage 1120 configured to store a performance review. Performance Review Storage 1120 may include random access memory, static memory, non-volatile memory, volatile memory, a hard drive, an optical drive, magnetic media, optical media, and/or other digital storage devices. Performance Review Storage 1120 is optionally configured to store a database of performance reviews associated with a plurality of employees. The performance review database includes performance review identification information including the name of the employee, the job title of the employee, the name of the employees supervisor, the duties associated with the job of the employee, information about the employee's performance on the job written as prose by the employee, scores given to the employee by the themselves rating various job behaviors or outcomes, information about the employee's performance on the job written as prose by the performance review author, scores given to the employee by the employee's supervisor rating various job behaviors or outcomes, information about the employee's performance on the job written by colleagues or clients of the employee, scores given to the employee by the employee's colleagues or clients about the employee's performance on the job, quantified employment data about the employees performance (for example, number of bugs per line of code or number of support cases resolved per hour), and/or the like. Typically Performance Review Storage 1120 includes a data structured specifically configured to store this information.

The information may have been entered into the Performance Review Storage 1120 when it was provided by the person responsible for creating the performance review via a browser. Alternately, it may have been entered into the Performance Review Storage 1120 by another process, the Data Upload Logic 1115, is further optionally configured to upload the data associated with one or more author profiles into the Performance Review Storage 1120.

Performance reviews stored in Performance Review Storage 1120 are optionally grouped in performance review “families.” Performance review families may include performance reviews in the same company, in the same organization, having similar titles and/or responsibilities, or any multidimensional combination of the above.

Performance Review Management System 1100 further includes Bias Data Memory 1130 configured to store information about various forms of biases, various indicators of those biases, various techniques for mitigating those biases and various descriptions of the biases, and/or the reasoning behind the biases and the mechanisms for mitigating the biases.

The Bias Data Memory 1130 optionally contains one or more of the following: words and/or phrases that are known to be biased against gender, race, or some other demographic or stereotype (an example of these words is “aggressive” which is known to be used for female employees where “assertive” is usually used with male employees); the types of performance that should be evaluated for all employees (an example is rating every employee on both accomplishments and potential); including work tasks that tend to be typically female-oriented in the consideration of performance (for example, note taking in meetings, organizing parties, etc.); etc. Typically Bias Data Memory 1130 includes a data structured specifically configured to store this information.

The Bias Data Memory 1130 optionally contains words or phrases that can be used as part of mitigation techniques for removing bias or descriptions of procedures that can be taken to remove bias from a performance review. Examples of a data and procedures that can be used for mitigation techniques include but are not limited to changing a biased term to a neutral term (for example, changing “aggressive” to “assertive” or suggesting that authors do not use the term “tone” in their performance review), ensuring that all employees are rated on both performance and potential, including typically female-oriented tasks (organizing parties) in evaluating performance for both male and female candidates, prompting the author to recall positive components of the employees past performance, prompting the author to recall negative components of the employees past performance, reminding the author of the aspects of the job that are important to the performance of the job, etc.

Performance Review Management System 1100 further includes Bias Scoring Logic 1135 configured to parse performance reviews and to calculate a score that is the indication of the amount of bias present in the performance review (a bias score). In some embodiments, Bias Scoring Logic 1135 includes computer code configured to present a web interface to a user within a browser. In some embodiments, Bias Scoring Logic 1135 includes computer code configured to present an interface to a person through their cellular telephone or other telecommunication device. In this case there is often an application created that is used on the phone or other communication device.

Example calculations that can be performed by the Bias Scoring Logic 1135 include, but are not limited to, the indication of biased terms, the lack of evaluating someone on performance or potential, the lack of scoring someone on typically female-oriented tasks, the lack of providing examples of positive and negative aspects of the employee's performance (using a free recall strategy). It has been shown that when the author is asked to think about both positive and negative aspects of an employee's performance—this is known as free recall—this can reduce bias associated with the author's expected performance outcome for the employee. As an example, an author may have a bias that employees who went to a non-Ivy league school will not be able to present as well as other employees. When an author is prompted to use free recall to think about positive and negative aspects of an employee's performance they are more likely to recall performance by the employee that is not associated with the bias of the author. In this example, if the employee had done a good presentation, the free recall exercise may prompt the author to rate the employee high on presentations even if the employee did not attend an Ivy-league school. An additional example reminds the author of the performance review about what is most important for the performance review. As an example, since women can be judged as “not speaking up enough” and also “talking too much”, Performance Review Management System 1100 may optionally remind the author of the performance review that the most important aspects of the performance review are things like “accomplished goals set forth in performance plan”, and other quantifiable and relevant tasks associated with the employee's performance. An additional example uses the potential biases of the author to increase or decrease the score based on some component of the performance review. For example, if the author is male, the performance review may be scored as more biased if the scores for importance of typically female-oriented tasks are marked as less important than other tasks.

An author may enter and/or modify various components of a performance review. The calculation of the bias score is based on the information stored in the Bias Data Memory 1130 in combination with the various components of the performance review. The score represents a result of a calculation of the various components of the Bias Data Memory 1130 as a function of the information in the performance review. In various embodiments, there are a wide variety of methods by which a score can be calculated. In some embodiments an equation (e.g., a linear equation) is used that includes bias values multiplied by coefficients. The coefficients are based on information such as magnitude of bias per component or number of existing components that represent bias among others.

The score calculated using Bias Scoring Logic 1135 is typically configured for showing the user of the system, who is the author or modifier of the performance review, when their changes or additions to a performance review make that performance review more or less biased. The score generated by Bias Scoring Logic 1135 can optionally be displayed in real-time and/or be displayed based on a previous calculation. An example of the score being displayed in real-time includes when the author types the word “abrasive”, the score would change immediately and the word would be highlighted to show that it is known to be a word that is used when the author is biased. Bias Scoring Logic 1135 is optionally configured to calculate a grade based on a score. A grade is a representation of a score normalized to a grading scale such as A to F, 1 to 10, one star to five stars, “Very Good” to “Very Bad,” etc.

Bias Scoring Logic 1135 optionally includes Binary Calculation Logic 1140 and a Non-Binary Calculation Logic 1145. Binary Calculation Logic 1140 is configured to calculate a score based on binary values, such as the presence of a particular words or phrases in the performance review. For example, a performance review may include words or phrases like “abrasive” or “watch your tone” which have been shown to be included in female performance reviews, but less so in male performance reviews. In this case, a binary score of one may be included indicating that the performance review is unfairly written to judge the employee on something that men are not typically judged on. Binary Calculation Logic 1140 may use Boolean logic. Binary Calculation Logic 1140 is typically used to dramatically alter scores for specific components of the performance review that are absolutely to be avoided. Different factors can be weighted differently in the calculation.

Binary Calculation Logic 1140 optionally includes whether or not the employee has been rated on both accomplishments and potential. It is shown that men tend to get more promotions and higher ratings because reviewers look at their potential in addition to their accomplishments. Women are often passed over for promotion or given lower ratings in performance reviews because the evaluator wants “proof” that a woman can perform in a certain way. Asking reviewers about both achievements and potential in a systematic way, reduces the possibility that women will only be rated lower than men when they have the same performance as a man.

Binary Calculation Logic 1140 optionally includes whether or not typically female-oriented tasks are included in the performance review. Because women are often tasked with typically female-oriented tasks (like taking notes in meetings, organizing parties, mentoring others, and the like), this can hurt the appearance of how well they performed since these tasks take up time but are often not counted towards their accomplishments. By prompting the reviewer to indicate which typically female-oriented tasks have been accomplished by the employee—and remind the reviewer that these tasks are important for the success of the organization—it reduces the likelihood that an employee who has contributed a lot of these typically female-oriented tasks will be rated lower in their performance review than someone who has not performed many typically female-oriented tasks.

Binary Calculation Logic 1140 is optionally configured to calculate scores based on whether the author has included responses to the questions posed by the system about the positive and negative aspects of the employee's performance as part of the free recall portion of the performance review.

Binary Calculation Logic 1140 is optionally configured to calculate scores based on whether the author has the possibility of being biased in any way. These calculations are based on a plethora of information including but not limited to the author's background, ethnicity, religion, preferences, results of psychological, personality or other tests, indications from the author's co-workers or managers, etc. This information can be used to increase or decrease the bias score based on whether or not the author is likely to have a particular bias.

Non-Binary Calculation Logic 1145 is configured to calculate a score based on quantitative information within the performance review. For example, the calculation of a score may include multiplying the number of biased words by a coefficient. The coefficient can be positive or negative.

Non-Binary Calculation Logic 1145 is optionally configured to calculate scores based on the different components of the job being performed by the employee, the priority of each of those components and how well the employee rates on each of those components. An example is that a particular job requires delivering a weekly spreadsheet, completing Project A within X months, and interacting well with teammates. The author might specify a score for each component based on how important it is to getting the job done. That score could be a value from 0 to 100 or some other representation for the importance of the component in accomplishing the job. Then the author might rate the employee on how well they performed each component. That rating may be a number from 0 to 10 or 0 to 100. In addition, peers and/or other colleagues can give ratings for the employee. Non-Binary Calculation Logic 1145 then computes a score based on the weightings of the components and the corresponding ratings of the employee for each component.

Non-Binary Calculation Logic 1145 is optionally configured to calculate scores based on the number of responses the author has included to the questions posed by the system about the positive and negative aspects of the employee's performance as part of the free recall portion of the performance review.

Non-Binary Calculation Logic 1145 is optionally configured to calculate scores based on whether the author has the possibility of being biased in any way. These calculations are based on a plethora of information including but not limited to the author's background, ethnicity, religion, preferences, results of psychological, personality or other tests, indications from the author's co-workers or managers, etc. This information can be used to increase or decrease the bias score based on whether or not the author is likely to have a particular bias.

Performance Review Management System 1100 typically includes Presentation Logic 1160 configured to provide scores and or grades to an author and to allow an author to make changes or additions to their performance review to influence their score. In typical embodiments, Presentation Logic 1160 is configured to generate computing instructions (e.g., html, xml, scripts, java, or the like) configured to present an interface to an author within a browser. Alternatively, Presentation Logic 1160 is configured to present information to an author via a software agent. Part of Presentation Logic 1160 is optionally disposed on Computing Device 1175.

Presentation Logic 1160 is typically configured to receive inputs from an author. These inputs may include text to be included in various components of the performance review, scores of various components of an employee's performance, commands to print a performance review or groups of performance reviews, customization of an author profile, the ability to save a performance review, the ability to analyze a performance review, the ability to indicate that a performance review is ready for review by another user, and/or the like. For example, in some embodiments, Presentation Logic 1160 is configured to present a search field to a user through a browser. The search field is configured for a user to search for a performance review by name of the employee, company, organization within the company, author of the performance review, title of the employee, and/or the like.

Performance Review Memory 1165 is optionally configured to store the prose associated with the performance review. This prose can be from the employee, the employee's manager, colleagues of the employee, etc.

Performance Review Memory 1165 is optionally configured to store the scores associated with various aspects of the employee's performance. These scores can be from the employee, the employee's manager, the employee's colleagues, and others.

Performance Review Memory 1165 is optionally configured to store performance metrics of the employee in their job.

Performance Review Memory 1165 is optionally configured to store a priority or score associated with various components of the performance review. For example, a manager may indicate that typically female-oriented tasks are less important than quantitative performance outcomes. Typically Performance Review Memory 1165 includes a data structured specifically configured to store this information.

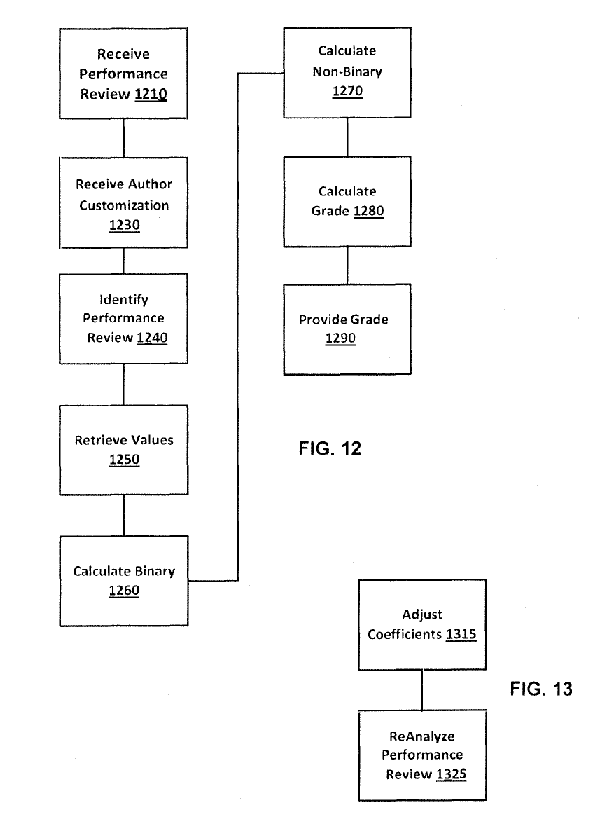

FIG. 12 is an illustration of a method of providing a grade for a performance review to an author, according to various embodiments of the invention. The grade is based on various indications of potential bias in a performance review as associated with the performance review in question. One or more of the method steps illustrated in FIG. 12 are optionally performed using the Performance Review Management System 1100 and can be performed in alternative orders.

In an optional Receive Performance Review Step 1210 an indication of the performance review to be analyzed is received by Performance Review Management System 1100. This indication is optionally received via a browser or application and may include the author selecting from among a plurality of performance reviews in a menu. The received indication is stored in Profile Memory 1110 in association with the author.

In an optional Receive Author Customization Step 1230 Performance Review Management System 1100 receives a customization of the author's profile. This customization is typically under the direction of the author or a manager of the author. In some embodiments, the received customization may include modification of any of the professional or personal data or other information that can be stored in the profile of the author. The customization may be received over Network 1170 from Computing Device 1175.

Receive Performance Review Step 1210, and/or Receive Author Customization Step 1230 are optional in instance where a profile for the author or a performance review is already available.

In an Identify Performance Review Step 1240 a performance review is identified. This identification may include the selection of the performance review by the author from a list of performance reviews, the author providing an identifier of the performance review (e.g., an employee's name), or the identification by Performance Review Management System 1100 of performance reviews within the same category as another performance review. For example, in some embodiments, Identify Performance Review Step 1240 includes searching Performance Review Storage 1120 for a performance review in a specific category.

In a Retrieve Values Step 1250 multiple components associated with the performance review identified in Identify Performance Review Step 1240 are retrieved from Performance Review Storage 1120. This retrieval is optionally accomplished using a database query. The performance review components may include the name of the employee, title of the job, prose about the employee's performance, scores associated to the employee's performance, and other information discussed herein.

In an optional Calculate Binary Step 1260 a binary score for the performance review identified in Identify Performance Review Step 1240 is calculated using Binary Calculation Logic 1130. This calculation is based on the performance review customized in Receive Author Customization Step 1230 and on one or more of the performance review components retrieved in Retrieve Values Step 1250. As discussed elsewhere herein, the calculation of a binary score optionally includes the use of Boolean operations.

In an optional Calculate Non-Binary Step 1270 a non-binary score for the performance review identified in Identify Performance Review Step 1240 is calculated using Non-Binary Calculation Logic 1145. This calculation is based on the components of the performance review customized in Receive Author Customization Step 1240 and on one or more of the performance review components retrieved in Retrieve Values Step 1250.

In an optional Calculate Grade Step 1280 a grade is calculated from the binary score calculated in Calculate Binary Step 1260 and/or the non-binary score calculated in Calculate Non-Binary Step 1270. This grade is relative to a grading scale and, as such, is configured for comparison with grades calculated for other performance reviews. The calculated grade is intended to represent the amount of bias apparent in a performance review. In some embodiments, the binary and non-binary scores are combined without normalization to a grade.

In a Provide Grade Step 1290 the grade calculated in Calculate Grade Step 1280, the binary score calculated in Calculate Binary Step 1260, the non-binary score calculated in Calculate Non-Binary Step 1270, and/or a combination thereof is provided to the author or other individuals who should have access to this score (for example, the author's manager, human resources professionals within the organization, etc.). This information is provided using Presentation Logic 1160 and is optionally provided via Network 1170 to Computing Device 1175A or 1175B. For example, the information may be displayed on a browser within Computing Device 1175A. In some embodiments, grades or scores for multiple performance reviews are displayed together for comparison by the author or others. In other embodiments, a time series of grades for one or more performance reviews is displayed for the author or others so that the author or others can see the change in biases in one or more performance reviews as changes were made over time.

FIG. 13 is an illustration of a method of comparing performance reviews, according to various embodiments of the invention. In this method grades for several performance reviews are calculated or retrieved and provided to an author or others for comparison. Also, multiple grades for the same performance review can be displayed in a time-series for comparison by the author or others. For example, if a performance review received a grade of “C” on Jan. 1 and was modified on Jan. 2 and then received a grade of “B”, a time-series chart could show the author or others the change to the score of the performance review as changes were made. Similarly, the grades for a particular employee over time can be shown. For example, if the employee received a grade of “C” on Jan. 1, 2010, “B on Jan. 15, 2011, and “B” on Jan. 12, 2012, this progression of grades for a single employee may be displayed.

In addition, performance reviews aggregated for a group of employees can be displayed. For example, the vice president might want to see the aggregated reviews for his or her entire department or for each group within his or her department.

The methods illustrated by FIG. 13 are optionally performed using Performance Review Management System 1100. The steps illustrated in FIG. 13 may be performed in a wide variety of alternative orders.

In an optional Adjust Coefficients Step 1315 coefficients used by Score Calculation Logic 1125 are adjusted based on the tolerance for various types of biases. As a result, scores for all of the performance reviews associated with those coefficients may change based on a change to the coefficients. In this embodiment, a ReAnalyze Performance Review Step 1325 can be run to re-analyze the performance reviews in the class for which the coefficients have been adjusted.

In the case of the ReAnalyze Performance Review Step 1325 being run, the previous grades of the performance reviews are stored and an additional value is stored in the Performance Review Storage 1120 to indicate that a change was made to the coefficients prior to this running of the grading of the performance review.

Thus, in FIG. 13 when performance review grades are displayed, an indication is shown to the author or others through the Performance Review Management System 1100 that there was a change to the coefficients prior to obtaining the displayed grade.

1. (canceled)

2. A computing system configured to reduce bias in the authoring of self-performance reviews, the computing system comprising:
a user interface configured to a human user to enter words of a performance review of themselves;
a user interface configured to remind the reviewer of the attributes that are relevant to the performance of an individual in the job;
a rule base comprising a plurality of rules for the content of a performance review, the plurality of rules including
a rule to avoid specific terms in the performance review,
a rule to encourage the use of specific terms in the performance review,
a rule to encourage the accomplishment of “household tasks” at the office (taking notes in meetings, mentoring, organizing parties), and
a rule to have reviewers consider both performance and potential when writing a performance review of one self;
analysis logic configured to generate a score for the self-performance review, the score being based on compliance of the self-performance review to the plurality of rules;
storage configured to store the performance review and the plurality of rules; and
a microprocessor configured to execute at least the analysis logic.

3. The system of claim 2, wherein the user interface includes a wizard configured to guide the user to enter parts of the performance review one part at a time.

4. The system of claim 2, wherein the rule to avoid specific terms is a rule to avoid specific gender biased terms.

5. The system of claim 2, wherein the rule to include specific terms is a rule to ensure reviewees are reviewed on the same criteria, regardless of gender, race, sexual preference, etc.

6. The system of claim 2, wherein the rule to include whether or not the person reports doing “household” tasks at the office—taking notes, organizing parties, mentoring—is meant to show the accomplishments of women that are often ignored.

7. The system of claim 2, wherein the rule to ensure that all persons being reviewed are reviewed on both performance and potential is a rule to ensure reviewees are reviewed on the same criteria, regardless of gender, race, sexual preference, etc.

8. The system of claim 2, wherein a score for the review is calculated either in real-time or after the review has been completed where the score shows the amount of bias in the review. A score is optionally calculated is each field is completed, each section is completed, or on a word-by-word basis. The score is optionally associated with an explanation of the factors that contributed to lowering or raising the score.

9. A computing system configured to reduce bias in the authoring of performance reviews, the computing system comprising:
a user interface configured to a human user to prompt the human user to describe several positive aspects of the reviewee using specific job-relevant questions;
a user interface configured to a human user to prompt the human user to describe several negative aspects of the reviewee using specific job-relevant questions;
a user interface configured to a human user to enter words of a performance review;
a user interface configured to remind the reviewer of the attributes that are relevant to the performance of an individual in the job;
a rule base comprising a plurality of rules for the content of a performance review, the plurality of rules including at least two of:
a rule to avoid specific terms in the performance review,
a rule to encourage the use of specific terms in the performance review,
a rule to encourage the accomplishment of “household tasks” at the office (taking notes in meetings, mentoring, organizing parties) and
a rule to have reviewers consider both performance and potential when writing a performance review;
analysis logic configured to generate a score for the performance review, the score being based on compliance of the performance review to the plurality of rules;
storage configured to store the performance review and the plurality of rules; and
a microprocessor configured to execute at least the analysis logic.

10. The system of claim 9, wherein the user interface includes a wizard configured to guide the user to enter parts of the performance review one part at a time.

11. The system of claim 9, wherein the rule to avoid specific terms is a rule to avoid specific gender biased terms.

12. The system of claim 9, wherein the rule to include specific terms is a rule to ensure reviewees are reviewed on the same criteria, regardless of gender, race, sexual preference, etc.

13. The system of claim 9, wherein the rule to include whether or not the person reports doing “household” tasks at the office—taking notes, organizing parties, mentoring—is meant to show the accomplishments of women that are often ignored.

14. The system of claim 9, wherein the rule to ensure that all persons being reviewed are reviewed on both performance and potential is a rule to ensure reviewees are reviewed on the same criteria, regardless of gender, race, sexual preference, etc.
